(19) United States
(12) Patent Application Publication
(10) Pub. No.: US 2024/0328644 A1
(43) Pub. Date: Oct. 3, 2024

(54) SYSTEMS AND METHODS FOR CLEANROOM MANAGEMENT

(71) Applicant: Clean Spaces App, LLC, Chuluota, FL (US)

(72) Inventors: Kamal I. Latham, Gainesville, FL (US); Mark D Proulx, Chuluota, FL (US); Nahu Alula, Tampa, FL (US)

(73) Assignee: Clean Spaces App, LLC, Chuluota, FL (US)

(21) Appl. No.: 18/625,238

(22) Filed: Apr. 3, 2024

Related U.S. Application Data
(60) Provisional application No. 63/456,537, filed on Apr. 3, 2023.

(51) Int. Cl. F24F 3/167; G01N 15/14; G06F 16/38

(52) U.S. Cl. CPC F24F 3/167; G01N 15/14; G06F 16/38; G01N 2015/1486

(57) ABSTRACT

Systems and methods for cleanroom management configured for the electronic detection and processing of airborne and/or surface particle content in which the input of data is taken and the output produces an audit log, a pass/fail certification, a microbe count, a particle count, and/or the use and/or measure of Business Intelligence (BI) data analytics. The gathering of the type of class of cleanroom being certified occurs along with the input the number of people, number of devices to be cleaned, and/or cleaning solutions.

### CROSS-REFERENCE TO RELATED APPLICATIONS

This application is a U.S. Non-Provisional Patent Application entitled, “SYSTEMS AND METHODS FOR CLEANROOM MANAGEMENT” that claims priority to U.S. Provisional Patent Application No. 63/456,537, filed on Apr. 3, 2023 entitled, “SYSTEMS AND METHODS FOR CLEANROOM MANAGEMENT” the contents of which are hereby fully incorporated by reference.

### FIELD OF THE EMBODIMENTS

The field of the invention and its embodiments relates to systems and methods for cleanroom management, and more particularly to the electronic detection and processing of airborne particle content.

### BACKGROUND OF THE EMBODIMENTS

Current cleanroom management techniques are configured for detection of particles. There is a need to ensure that cleanrooms such as lab spaces are compliant with the United States Food and Drug Administration (FDA) inspection and approval process. Normally, the industry uses paper forms to get the FDA certification. However, it may be time consuming and burdensome to locate the most updated forms with the most up to date requirements. Further, the process of comparing the measured type and quantity of particles and/or microbes detected in a particular room with those requirements, set forth by the FDA and/or any predetermined criteria, may be prone to human error. Thus, there is a need to simplify and standardize this process to ensure a cleanroom passes a validation process.

### Review of Related Art

CN115307679A—This reference discloses a clean room wireless remote monitoring system, including an information collection module, a data analysis module, a real-time monitoring module, a data transmission module, a clean room environmental control module, an early warning module, and a clean room internal data stabilization module.

KR1020220114163A—This reference describes a cleanroom particle integrated management system installed inside the cleanroom and has at least one particle sensing device that detects particles contained in the air and counts the quantity of particles; a data management server that is communicatively connected to at least one particle sensing device, obtains air cleanliness data according to the quantity of particles contained in the measured air from the particle sensing device, and classifies and manages the acquired air cleanliness data; and a monitoring device that is communicatively connected to a server for data management to monitor the air cleanliness inside the cleanroom in real time, and thereby control the air cleanliness inside the cleanroom.

US11288945B2—This reference describes methods and systems for monitoring procedural compliance of staff in a facility.

PL130105U1—This reference discusses a clean room with at least one limited volume, comprising at least one entrance door, at least one filter and ventilation unit (FFU), at least one opening associated with a filter opening of a thickness contained between 10 mm and 100 mm, and preferably a system for the immediate determination of the level of particles inside it, which contains at least one particle counter, at least one user interface for the immediate display of particle levels inside the cleanroom; and at least one central processing unit.

CN110260916B—This reference teaches a clean room environment monitoring management system comprising an environment monitoring management platform. The environment monitoring management platform includes a first-level regional monitoring module. The output terminal of the first-level regional monitoring module is connected with a crosstalk analysis module electrically. The input terminal of the crosstalk analysis module is electrically connected to a second-level regional monitoring module.

CN214474491U—This reference discloses a key clean room user information monitoring management platform, and relates to the technical field of electronic software. The system is composed of a data input module, a data storage module, a data analysis module, an access control management module, a data collection module, a display module, an environment monitoring module, a video monitoring module and a body temperature monitoring module.

US11079777B2—This reference discloses a system for verification of conditions of a clean room, comprising: a controller; a valve coupled to the controller; a heating mechanism in the clean room, connected to the controller; a cooling mechanism in the clean room, connected to the controller; and one or more sensors connected to the controller.

US10978199B2—This reference discusses a method for controlling a building management system of a medical facility including a plurality of rooms with at least one of the rooms having a plurality of sensors, wherein an elevated infection risk determination system is operative coupled to the plurality of sensors.

US10606289B2—This reference discloses a system and approach for verifying and validating a room condition and its behavior in a critical environment. The system and approach may be web-based and used to test and verify the room condition per preset conditions. The system may have steps or tabs.

CN109540202A—This reference teaches monitoring data acquisition module, a function partition module, an input information acquisition module, a data analysis module and an information prompting module.

U.S. Pat. No. 10,184,880B2—This reference teaches an airborne particle-measuring device quantifies and qualifies contaminants of an air environment in clean-rooms, open spaces, and enclosed spaces such as homes, offices, industrial environments, airplanes in flight, cars and others. The device may include a sensor system, an electronics system, communications and information storage.

CN108106669A—This reference discloses a machine room environment state monitoring system, and relates to the field of automatic monitoring of the environment of a machine room.

U.S. Pat. No. 9,311,807B2—This reference illustrates an environmental monitoring device comprising a data bus, a multitude of sensors, at least one processing unit, an input/output device, a communications interface, and memory.

US20150056909A1—This reference describes a system for managing cleanroom resources by providing a number of critical features in an integrated, low-cost package for monitoring and recording cleanroom environmental conditions such as temperature, humidity and room differential pressure, notifying users of alarm situations when cleanroom environmental conditions fall outside predetermined limits, and reducing cleanroom energy usage by turning off HEPA filter fan units (FFUs) and cleanroom lights when not needed.

### SUMMARY OF THE EMBODIMENTS

In accordance with the principles of the present invention, systems and methods for cleanroom management are configured for the electronic detection and processing of airborne particle content in which the input of data is taken and the output produces an audit log, a pass/fail certification, a microbe count, a particle count, and/or the use and/or measure of Business Intelligence (BI) data analytics. The gathering of the type of class of cleanroom being certified occurs along with the input of the number of people, number of devices to be cleaned, and/or cleaning solutions, and which also includes improvements that overcome the limitations of prior lab information management system (LIMS) solutions, is now met by a new, useful, and non-obvious invention.

### Additional Information

Some capabilities of the system include, but are not limited to, automated data management and processing system, recording of the company's approved supplies, save listing of approved supplies, save listing of approved equipment, auto display approved supplies and/or equipment, allow administrators (admins) to set up users, admins may sign on anytime, the capability of being cloud-based, having defined procedures to reduce infection risk, allowing for recording of the cleaning, allowing for recording of the disinfecting, auto creating audit log of activities, allowing for recording of particle counts, allowing for recording temperature and/or humidity, allowing for recording air changes per hour, allowing for recording pressure differentials, having an internal database of ISO standards, automatic particle Pass and/or Fail status based on inputs, automatic output of historic particle counts, allowing for recording of micro counts (air), allowing for recording micro counts (surfaces), allow for identification of microorganisms, automatic micro Pass and/or Fail status based on inputs, notifications of open jobs and/or activities, automatically generating charts for particle/micro, printed and/or PDF data exported electronically, the application program is expandable for more users and/or rooms, verification of all work activities, and/or easy menu driven system.

In some embodiments, the system's capabilities are supported by a combination of hardware components and software functionalities. Automated data management and processing are facilitated by a central processing unit (CPU) or microcontroller, while recording of approved supplies and equipment can be achieved through the integration of barcode scanners or RFID readers. Cloud-based capabilities leverage servers and networking equipment to enable remote access and storage of data. Defined procedures for reducing infection risk rely on sensors and actuators for monitoring and controlling environmental conditions. Recording of cleaning and disinfecting processes can be done using cameras or sensor arrays, with audit logs automatically generated by the system's software. Particle and microbial counts are captured using specialized equipment integrated into the system, while microbial identification systems aid in identifying specific microorganisms. Notifications and charts are generated based on collected data, and the system's expandable architecture allows for scalability without significant hardware modifications. Verification of work activities is ensured through biometric scanners or authentication devices, while intuitive menu-driven interfaces facilitate user interaction with the system.

As noted above, in some embodiments, the system employs a variety of sensors to monitor key parameters within the cleanroom environment. Temperature and humidity sensors are utilized to track ambient conditions, ensuring that the room maintains the required levels for cleanliness and comfort. Particle counting sensors are configured for detecting and quantifying airborne particles, providing insights into air quality and filtration effectiveness. Pressure sensors monitor differential pressures between cleanrooms and adjacent areas, facilitating proper airflow and containment of contaminants. Additionally, microbial sensors are employed to detect and quantify microbial contamination on surfaces and in the air, enabling proactive measures to maintain cleanliness standards. Barcode scanners or RFID readers are used for tracking approved supplies and equipment, while camera systems capture visual data to record cleaning and disinfection activities. Together, these sensors form a comprehensive monitoring system that ensures compliance with cleanliness protocols and facilitates effective management of the cleanroom environment.

Potential client must be able to communicate how many rooms and users are desired in their platform, as a result, the total price label will dynamically increase as the amount of data increases, the number of cleanrooms, the size of the cleanrooms, and/or the number of users increases. Customer Service (CS) shall send a paid client a code that will allow the administrator (admin) to download a web version of the app, temporary login credentials and an associated URL, which grant access to the Content Management System (CMS) or their company's administrative panel (admin panel). Thus, Twilio will send a One Time Password upon each user request. Upon first login to the admin panel, Twilio will send a One Time Password to verify the email. A dashboard shall only allow an admin to input up to, but no more than, the number of users and cleanrooms paid for. Upon onboarding, admins can register the requested users. These accounts will hold default values until an admin invites each user via an email-invitation-feature. In particular, an admin will register each hardware device (e.g., iPad, Surface Pro) and register each user to be using the app. Each user may use any of the hardware devices at any time since they are authorized by the admin. Users and/or clean rooms may be added and/or removed as desired by the admin, so long as they are limited to what has been paid for. In an example, adding a new user will force an increase in the recurring monthly unit cost. In another example, removing a user will decrease recurring monthly unit cost. It is within the scope of this invention for any new user(s) over the amount paid for by the client, to result in a change to monthly pricing. Clients may have any registered number of users below that without changes to the pricing.

Administrators (admins) must have the ability to enter in names of cleanrooms (some unique alpha-numeric description), locations, and users. 1. Clean room titles are mandatory in order to save to database. 2. Editing of any clean room title will create a historical trail within the audit log. Admins will have the ability to register users with a unique username and password, at a minimum. 3. In an embodiment, at least one location is mandatory for each added clean room. It is within the scope of this invention for a location within the cleanroom to be created by an admin. In an embodiment, after the initial onboarding, to be in compliance with 21 CFR Part 11, admins may manually invite any new users with an email invite feature. Each email will open to an onboarding portal requesting name and phone number from respective new user. It is within the scope of this invention for an admin to register all employees who will use the app in the admin software. Once registered, and at the time of initial log-on, users will input their username and password and may be asked for a photo to be used (which the device will take). If chosen, a user may use facial recognition software built into the device instead of typing username and password each time to log in.

The app may use facial recognition or biometrics as log in options. Facial and/or Fingerprint ID will be optional authentication methods by default but can be set to mandatory in the admin panel. Note that this app will not run on any device using an iOS device with a 4th generation or earlier operating system. Admins must have the ability to input cleaning and disinfecting supply names. Admins can add, remove, or edit all cleaning/disinfecting product names and/or pin numbers. It is within the scope of this invention for users to input a lot number and/or an expiration (EXP) date. In an embodiment, a limit of two hundred product names can be stored. It is within the scope of this invention for any amount of product names to be stored within a database of the computer program.

Admins must have ability to choose the ISO/FS-209E/PIC/S classification of the rooms. Each room will require admins to assign an ISO/FS-209E/PIC/S classification using checkbox functionality, for compliance testing (particulates). It is within the scope of this invention for any future classifications to be included from this selection list. Admins must have ability to dual-classify rooms. For example, the checkbox functionality allows for one room to contain multiple classification indexes (i.e., Class 5 and Class 7 or equivalents) and options (i.e., 0.5 vs 5.0). Admins must have ability to choose the number of contact, settle and impact plates used per room for microbial testing. Admins can add, remove, and/or edit all plates. Each plate requires a singular room location assignment. It is within the scope of this invention for any number of each type of plate per room to be available. Admins must have ability to input free text describing a location for each plate for compliance with standard operating procedures (SOPs), quality management systems expectations, and regulatory standards. Each location will have an optional description containing data. A required numerical text box allows admins to set a maximum limit of organisms (CFU) per location. Admins must have ability to record a maximum limit of organisms (CFU) that may be at each location. A required numerical text box allows admins to set a maximum limit of organisms (CFU) per location. There is a need for free text because some clients may have more stringent requirements than what is recommended.

Admins must have ability to record maximum number of organisms (CFUs) counted that will fail a plate and an overall average in which the room will fail if the average does per type of plate. Numeric text box allows admins to place required maximum limit on organisms (CFU) per location. App will allow admin to determine if recording air changes is mandatory, according to SOPs. If chosen, this becomes a required field for the users to input calculated or measured air changes per room within the particle counting menu. Values entered into numeric text box and/or ticker. All transactional data must be recorded in an audit log that cannot be edited. At each key save point, all key variables will be timestamped and stored in admin panel. These files will be exportable in csv, pdf, or xls format. Admins must be able to review audit logs and charts, and download them into PDF files which can be exported through email. Audit logs and charts will show all historical data with export via email functionality. These files will be exportable in pdf, csv, or xls format. Admins must be able to download a PDF of any transactional screen from the app. Admins must be able to register specific tablets (iPad, iPad mini, Surface Pro, etc.) as authorized devices running client's custom app up to the number of users. In order for an iPad/tablet to connect to a company's server, admin must register a device's unique identifier number (i.e., UDID, IMEI, MAC address, etc.) within admin panel. This will serve as an authorized device list.

CS will allow admin to remove and add as many tablets as a client has paid for. Admins must be able to register and download app to authorized devices up to the number of paid users. The app will be located on the private and possibly the public app store, with download accessibility via a link. Admins must have the ability to de-register a device and have de-registration immediately be changed at CS's master file. Any device can be removed from the authorized device list and will instantly lose the ability for any user to login or connect to server. Any preexisting local data will still be stored within that device but all data will exist in the cloud (AWS) database. Users must be authorized to use any registered device for their company's custom CS app. All devices in authorized device list will share a cloud (AWS) server. Data will be pushed to the cloud at every save point in the user app.

Users must be able to access the application software through a unique login (username and password) tied only to that user. Biometric authentication is an embodiment. User and server-side captchas may be used to prevent intrusions/bots. CS will not allow two sessions of the same username to be logged in at the same time. If the same account logs in from a second device, the initial user will receive an alert and an offer to logout. User must be presented with menu-driven first page that will allow them to choose: cleaning, disinfecting, particle counts, micro, charts, audit log, profile and/or sign out, at a minimum. User must be presented with notifications of open work orders, micro plates needing to be counted, and/or any other important task that is unfulfilled, including, but not limited to, rejected verifications from managers. Some tasks have daily, weekly, monthly, or quarterly designation. Algorithms for automated notifications are based on open tickets, rejected tasks, and/or failures. Notifications will clear automatically from the “to do” list after task has been successfully completed or closed by acceptance. App will have a way to click a notification icon and/or button to see each notification any time. All notifications, such as unread and/or read notifications, will be viewable from notification model. A user must have the ability to click “Cleaning” on the menu, then be taken to the cleaning screen. Cleaning screen will automatically show time and date of transaction opening. Time and date are adjusted for time zone. When in “Cleaning” screen, a user will be allowed to enter in the specific room that will be cleaned from an admin-specified drop-down list. A drop-down list of available rooms is pulled from admin panel. Drop-down list must only allow user to choose one room at a time using a single selection drop-down. User will be allowed to choose from daily, weekly, monthly, or quarterly, but only one may be chosen using a single selection button group. User will be allowed to choose which cleaning substances have been previously loaded into a drop-down, which will automatically include substance name and strength. User must be presented with substance specific data fields to record PIN, Lot No., and Expiration Date.

When a user makes up a bucket (or batch) of cleaning or disinfecting materials, the app must give user an option of receiving a unique number for that batch. A counter is provided that will output an increasing count upon click. For batch identification purposes, the app must give user a way to record different hardware or materials used in making the batch. Users can attach and fill in titles of specific hardware or materials to the selected room being used in the completion of this stage. App must give user the ability to choose all the locations in the room via a drop-down list in which multiple locations may be chosen. App must give user the ability to cancel out of the transaction (leaving no audit trail record) and/or saving. User may press the cancel option before the first save point to delete the event. Once a user opens a ticket, enters required data, and saves, the app will create an audit log of the transaction. There is no means of canceling out a completed ticket that has been saved; however, the admin will have ability to create notes or comments for this ticket, if needed, to explain an aberrant ticket opened and saved. Initially, admin may opt in to force each user transaction to be saved (tracked by audit log) and sent to their manager for verification. Once manager verifies the data is correct, verification step is transacted in audit log, as well. Should manager reject transaction with comments, this will be transacted within the audit log and a notification sent to user to make necessary corrections and resubmit. Upon saving a resubmitted ticket, the ticket will be transacted within the audit log until the manager verifies the ticket. Upon successful verification, the ticket will close, the audit log updated, and notifications for this ticket dismissed.

App must give the manager ability to accept or reject transaction. Pass/Fail Modal. If transaction is accepted, it is written into audit log and saved. If transaction is rejected, app will make a notes section available for providing information to user, then send a notification to user when confirmed. Manager must be given option of turning off verifications at their discretion. Although a verification switch (on/off) is located within admin panel, manager will need to request admin turn off verification for specific users. User must have ability to click “Disinfecting” on main menu, then be taken to the disinfecting screen. Disinfecting screen will have a drop-down for all approved substances available for use from admin panel to user app. Disinfecting screen will automatically show transaction opening time and date, which is captured and stored in the log. When in the “Disinfecting” screen, user will be allowed to enter in the specific room to be disinfected from admin-specified drop-down list.

Drop-down list must only allow user to choose one room at a time using a single selection drop-down menu. User will be allowed to choose from daily, weekly, monthly, and/or quarterly, but only one may be chosen. User will be allowed to choose which disinfecting substances have been previously loaded into a drop-down list by admin. User must be presented with substance specific data fields to record data including, but not limited to, name and strength, retrieved from admin panel. When user makes up a bucket (or batch) of disinfecting materials, app must give user an option of receiving a unique number for that batch. A counter will output an increasing count when clicked. App must give user a way to record different hardware or materials used in making the batch. Users can attach titles of specific hardware or materials (to the selected room) they used to complete this stage. App must give user the ability to choose all the locations in the room that were disinfected. Checkbox options for each disinfected location within a room. App must give the user the ability to cancel out of the transaction (leaving no audit trail record) and/or saving.

Each user transaction must be sent to manager for verification before transaction will be saved in audit log. App must give manager ability to accept or reject transaction. If transaction is accepted, it is written into the audit log and saved. If transaction is rejected, app will make a notes section available for providing information to user, then send notification to user when confirmed. Assigned managers will possess ‘voting’ privileges placing them at the receiving end of user generated Pass/Fail notifications. A user must have the ability to click “Particle Counts” on the main menu, then be taken to the particle counts screen. Particle counts screen will automatically show time and date of transaction opening, as well as name of the technician logged on. App must give user ability to choose the room to be measured using a single selection drop-down list of rooms pulled from admin panel.

App must give user the ability to choose between using internal particle counting equipment (company owned) or external third-party equipment (using their own equipment). Particle counting equipment (internal only) is entered in and pulled from the admin panel. When Internal is chosen, user will be given a drop-down list from which to choose approved equipment. The items list is pulled from admin panel. User must have ability to choose more than one piece of equipment to qualify the room. A button group with checkbox functionality may be used for making selections in a user interface and/or a webform. When External is chosen, user must fill in all boxes for each piece of equipment used: Model Name, Model No:, Serial Number, Cal Due Date, Test Sample Rate>CFM>LPM, Sample Height>FT>M, Sample Period>Min>Hrs. Normal keyboard and characters for model name. Numeric keyboard for Model No, Serial Number, Cal Due Date, Test Sample Rate, Height, Period. Numeric keyboard can reduce errors. User will be given buttons for “Next” or “Cancel”. When “Cancel” is chosen, a verification will open asking “Do you really want to cancel?” Yes/No. If “No” is clicked, verification notice will disappear, staying in the Particle Count screen until “Next” is clicked or unless “Yes” is chosen to cancel transaction. When “Next” is chosen, user will be taken to the next screen that will display current room classifications, along with particle sizes to be measured. User will choose room classification (if more than one), then choose particle size in which to input data. Particle sizes will have green READY (waiting for user inputs) next to it. User will have ability to input room air changes number.

Room air changes will be tied to admin inputs and once a number is entered, CS will automatically compare this entered number to the number agreed to by the admin, then display Pass/Fail. Pass/Fail room air changes will be timestamped and stored in the log. Failure can be one of two ways: fail a single count or fail the 95% UCL calculation average. In either case, a failure notice will be sent to the manager and admin and post to the audit log and chart for particle counts (rolling average over time). By clicking particle size, then next, the user will be taken to a screen into which they may enter particle size numbers. The user will enter decimals with up to 60 entries and at least seven (7)-digit whole numbers. Numeric keyboard. As the user is entering numbers, an AVERAGE, STANDARD DEVIATION and 95% UCL will be calculated real time. Average, standard deviation, and 95% UCL will calculate per entry. When the user has entered in all numbers desired into the thirty spots available, there will be an option on the screen to add an additional thirty numbers, if desired. See/Add more container. Once all numbers have been entered, the 95% UCL number will automatically be compared against an Admin input for that particular room and particle size. If 95% UCL is larger than the Alert Level automatically set by the admin, app will display FAIL. Save function performs Pass/Fail check against publicly available UCL dataset for the respective data. If one data point is larger than the Alert Level, that datapoint will show “Fail”; however, the 95% UCL may pass. Once there is a failure in either a single datapoint or the 95% UCL calculation, a notification will be sent to manager and admin.

When user clicks “ACCEPT,” they will be taken back to the original particle count screen. Applicable data will be stored as ‘ACCEPT’ is pressed. On this screen, the particle count will have a red COMPLETED next to it, showing that data has already been added. The completed particle counts are temporarily stored on the screen until all particle count screens have been COMPLETED. Any particle count screen that has not had data added will show READY in green next to it. Particle count screens cannot be COMPLETED without data being added by the user. When all particle count screens have had data entered, all particle counts will show red COMPLETED next to it and allow the user to accept. The particle counts are stored onto the log. Accepting the data input will bring user back to the start menu, finalizing the particle counts for a room and guiding user onto the next steps.

From the Start Menu, user will have the ability to choose “MICRO”. Single selection drop-down menu. Clicking MICRO will send the user to the first micro page. Upon entering the micro page, user is greeted with name, date and time transaction opened. User data is pulled from the log-in/account information; time/date adjusted for the time zone, captured and stored in log. User must have the ability to choose the specific room in which micro plates will be used. Single selection drop-down menu. Upon choosing the room, the number of plates will automatically display, including the name of the plate and location of where each plate is used according to how the admin preset the locations. Once plates have been used, the user must have the ability to start a timer from the moment the plates are put into incubation by clicking “Accept.” It is within the scope of this invention for the app to have a timer with a push notification and alarm reminders. User must have the ability to leave the micro transaction and have it saved for future inputs, keeping it as an “open transaction”. User entered data will persist within the micro screen after any save button is clicked. When a user closes the app and reopens, any timers or previously entered information will persist.

Default for micro numbers is a blank text box. A user will not have ability to submit to admin/manager until all required text boxes have values entered (required blank text boxes will appear for all the different plates needed per room). When user returns to the open micro transaction, user must have ability to enter in whole numbers next to each plate in the blank text boxes using an integer only keypad. All blank text boxes must have a whole number or app will not allow user to leave the screen. Should the device be powered off before all blank text boxes have been filled in, the app will continue to notify the user of an open transaction that needs to be completed. A user receives push notification and must enter integers into each micro transaction before submitting screen to manager for pass/fail review. After a user enters all numbers, the app will display “pass” or “fail” based on criteria stored from admin inputs for each datapoint per plate and overall average for the room. A “fail” by either a single plate or overall room average triggers notification to an admin/manager as well as an update to the log. CS must also automatically average these micro numbers for that specific room at the bottom of the page, making the average part of the permanent record. Micro number average is generated from the data recorded and stored into the log.

If a number greater than “0” (zero) is entered, a screen must be available to input information on the microorganism identified. Any value over zero makes microorganism information text box clickable (un-grey) and requires the user to input data before proceeding. Micro ID screen must allow the user to input more than one organism readily. When finished, the user must have the ability to accept the data and close the transaction. User is prompted to review inputted information after selecting “ACCEPT”. Upon review and completion, the app directs user back to the main menu and sends a verification notice (push notification) to the manager. From the main menu, the user must have the ability to click on audit log per room using a single selection drop-down menu. After clicking, a user must be taken to an audit log screen. An audit log must have the ability to record each and every completed transaction, as well as open tickets. Completed transactions will be listed in order of date ticket was initially completed. Filter options will include: date(s)/time, room or user. Each transaction must be able to be viewed in its own page to see transaction details. Single selection buttons are attached to each transaction, upon selection the app opens into complete review of transaction details. No editing functions are allowed on this screen.

User must have ability to download or email the transaction. A download icon and an email icon and/or button may be located at the top and bottom of the transaction details. A user may have the ability to take a screenshot of the audit log list, if desired. Screen shot capabilities are granted from the device and available within audit log screen. Audit logs can never be edited, modified and/or deleted. Audit logs have the capability of viewing, downloading, and/or email functionalities only. User must have ability to leave audit logs and return to main menu. A back icon and/or button will be placed at the top and bottom of each individual audit log and main audit log screen. At the main menu, user must have ability to choose chart icon using a single selection drop-down menu. After clicking Audit Log, user will be taken to a running list of all Audit Log transactions. On the screen, there will be buttons allowing user to filter the log by Cleaning, Disinfecting, Particle Counts, Micro or All (these buttons are part of the screen while displaying Audit Log entries).

Upon choosing particle counts, a user will, in addition to showing the entirety of the particle count transactions, be given a choice to choose a specific date or date range, rooms to view, and particle size recorded. Upon choosing CHARTS>Particle Counts, a user will be taken to the run chart showing Alert Level and datapoints for 95% UCL for specified room and particle size. Report generated from stored data within the logs. User must have the ability to actively return to the main menu or, after leaving a screen, app passively defaults to the main menu. Micro from the main menu, user will be presented with choice of rooms measured and charts for that room. Single selection list of CHARTS>Micro rooms listed in order of time/date the transaction was started. Filters will include date(s) and room name (alphabetical). Upon choosing CHARTS>Micro, there will be a drop-down list where user can select the room or plates and generate the run chart. A user must have the ability to download, screenshot, and/or email the chart. ‘Download’ and ‘email’ buttons are located at the top and bottom of the transaction details. The app must have the ability to “time out” after no longer than 15 minutes. After ten minutes, an audible and visual warning notification will be sent to remind users they will log out if they remain idle for 5 more minutes. After 15 minutes idle the user will be logged out. Upon time out, the user must be required to log back in and the app must return the user to the open transaction screen/last screen opened. A forced log out will immediately direct the user to the previous screen upon logging back in.

App must have ability to run on both iOS and Windows/Android systems, preferably tablets and mini tablets. App will be built using Flutter SDK which outputs to both iOS and Android devices. An initial document for the app project is to analyze technical work requirements based on provided information. It is within the scope for the computer program to have the feature of a “scheduler” to the application, in which, the client could schedule cleaning, disinfecting, particle counting, micro testing and have these activities come up as notifications. App development involves frontend and backend developers responsible for various aspects of the project. Frontend developers focus on Flutter and API integration, while backend developers manage API development, application, and user databases. The project's technologies include environment setup for database and Node JS, schema design as per the SAAS model, and backend APIs for different functionalities.

Under the resources section, environment setup for database and Node JS includes MongoDB setup and Node JS project setup connected to MongoDB. Schema design follows SAAS model using Mongoose, along with model classes creation and plugins for logging information. Backend APIs are categorized based on their functionalities, covering user authentication, room management, plate management, ISO classification, cleaner and disinfectant management, equipment management, cleaning, disinfecting, particulate count, microorganisms, charts, and logs. Features list encompasses functionalities, including cleaning, disinfecting, particulate count, microorganisms, charts, logs, authentication, admin screens, payment screens, notifications, walkthrough screens, and backend APIs for Node JS. Each feature involves specific setup, API integration, design, screen flow, and program logic development to ensure smooth functioning of cleanroom certification app.

It is within the scope of this invention for consumable supplies, such as cleaning and/or disinfection materials i.e., measuring cups to be written into a graphic user interface of a display allowing free text. App may opt for including, but not be limited to, a finite list to choose from rather than having to manually write it in every time. It is within the scope of this invention for a user to choose from a drop-down list of approved materials that actively do the Cleaning and/or Disinfecting. User may input free text for measuring cup, bucket, mop, etc. It is within the scope of this invention for the Pin and LOT numbers to have differing number of characters. In an example, there will not be more than 20 characters. Alphabetical/numerical characters may be input. It is within the scope of this invention for, on Particulate Count screens, if external is selected, additional equipment may be added. In particular, a user interface of a display may allow user to input a Name, Model Name, Model No., Serial Number, Cal Due Date, Test Sample Rate>CFM>LPM, Sample Height>FT>M, and/or Sample Period>Min>Hrs. It is within the scope of this invention for air change to be optional, as some companies, to qualify the clean room, have to calculate for air changes. There are recommended air changes per hour that go with clean room identifications according to the admin that the app will store and compare against when data is entered. Admin must state amount of air changes needed within the cycle or opt out of needing to input this data. Based on what admin inputs as the minimum for each cleanroom, then the user has to record air changes for that particular cleanroom. It allows the software to show whether it is within this bracket average and flag red if under limit given by admin.

When adding particle count data, the UI may need to have the day and time because that is part of the audit log to show when it has been recorded, for permanent record storage. UI likely doesn't need to be changed, as it may have an auto time stamp. It is within the scope of the invention for the date and time for start incubation to be positioned at the top of the display. When the plates are loaded and set up to put into the incubation room, so that it starts up then you go back to the app and click the incubation. Incubation has to be at the bottom. It is within the scope of this invention for this data to be displayed in a chronological order from top to bottom, left to right in order of importance. The start can auto time stamp.

It is within the scope of this invention for all charts to be relevant because it is an important aspect to check historically how much is in control within the particle counts. In an embodiment, discrete charts within these particle charts are made available per clean room. Enumerated, math difference between cleaning and disinfecting vs. the charts are to display the math that is being calculated. Audit logs (just to record) vs charts (statistics algorithms recorded within them). Charts will clearly show pass or fail of the 95% UCL according to the graphic, and the notifications of failing a single particle point for a particular room will be found within the transaction from the Audit Log. It is within the scope of this invention for a display screen to display to a client, audit logs and charts as well as main menu system particle counts audit logs and charts. It is possible to navigate from main menu to go back to click ‘audit log’ and be taken to the time range and/or to select a desired date. It is within the scope of this invention to incorporate more than one clean room at a time and/or to record one-by-one. In a one-by-one example, each clean room is its own manufacturing space/business and has its own controls. There may be two clean spaces within one floor, each clean space is its own business unit. A record may be per business unit. It is within the scope of this invention for the admins to have ultimate power and responsibility on the system. App is configured for iOS and Android. A client has the option to use the app with any device including, but not limited to, a tablet, a Surface tablet pro and/or apple iPad. A web-based program form admin POV may be accessible on a website so an employee is not required to work on a tablet. It is within the scope of this invention to check audit logs and charts from a phone by admin/manager phone screen point of view to be incorporated in an embodiment.

It is within the scope of this invention, if the information for the internal equipment in the ‘Particulate Counts’ screen is not the same model as the one displayed, then the users cannot use the equipment. This is a quality nonconformance that the client must rectify. The admin should be made aware that a new piece of equipment to be used in conjunction with the app is not yet approved for use. It is within the scope of this invention to select Internal if there is more than one machine, then user will choose from what drop-down list displays. If user chooses External, then manual input is required from equipment listed. User gathers information on external supplier and inputs information into app. If Internal uses something else from required list, then a user can't use it until admin authorizes use of equipment.

When employee opens a display screen, they need to open each step at the time they are doing the work and must match step-by-step. Supervisors have control of what they do. Two eyes on the page (manager/user) if experienced individuals go in and managers go in, they can turn verification off for specific users so they do not have to verify work. (Must be kept as an admin function at the manager's request.) Should be in the audit log and automatically sent to manager/admin. Audit log is used to see what has been done once user clicks OK on that step. It is within the scope of this invention for each individual business to be configured to handle scheduling. In an example, some businesses have monitored schedules cleaning rooms 2-3 times a day. Recording what is done is presented in audit log. In an embodiment, a scheduler may be implemented within the app.

In an example, it is within the scope of this invention for an employee to access the app to do cleaning. Within the display screen, an active and approved materials list selected by admin is presented and displayed. Employee chooses desired item and records with LOT, PIN numbers, and Expiration Date on the substance being used. Admin provides list. Once equipment has been entered, it needs to be locked in and no other equipment can be added to the flow. Air changes per hour is moved to particulate count screen. In an example, if the wrong number gets placed within input particle count, a warning label needs to be placed. Anything indicated as a failure when placing particle counts may be displayed within the same screen. If the resulting 95% UCL fails, it means room has failed and will be transacted in Audit Log. A notification will go to the manager and admin for this and any individual failure. Once client goes through process of cleaning, disinfecting, repair or maintenance, the record needs to be shown that the original attempt to prep the cleanroom failed.

In some embodiments, in Phase 1, Room Selection feature allows users to switch or select specific room they are working in, providing clarity on their location within the facility. Phase 2 introduces Worker Verification, where upon logging in, users are prompted to submit pictures of equipment and outfit being used, ensuring compliance with safety protocols and standards. In Phase 3, Picture Submission becomes part of task completion, as users are required to submit pictures for each task, whether it involves cleaning or disinfecting, providing visual evidence to admin to confirm task has been completed.

### BRIEF DESCRIPTION OF THE DRAWINGS

The present disclosure may be better understood, and its features and advantages made apparent to those skilled in the art by referencing accompanying drawings. Use of same reference symbols in different drawings indicates similar or identical items.

FIG. 1 depicts an illustration of a device showing an operational sequence for logging into a program account, according to at least some embodiments disclosed herein;

FIG. 1A depicts an operational sequence for resetting a password associated with an account of the program, according to at least some embodiments disclosed herein;

FIG. 1B depicts an illustration of a device showing an operational sequence for signing up for an account of the program, according to at least some embodiments disclosed herein;

FIG. 2 depicts an illustration of a device showing a menu page of the program, according to at least some embodiments disclosed herein;

FIG. 2A depicts an illustration of a device showing a dashboard having a welcome page of the program, according to at least some embodiments disclosed herein:

FIG. 2B depicts an illustration of a device showing a task list awaiting completion, according to at least some embodiments disclosed herein;

FIG. 2C depicts an illustration of a device showing a pending task list completed page, according to at least some embodiments disclosed herein;

FIG. 2D depicts an illustration of a device showing a complete task list completed page, according to at least some embodiments disclosed herein;

FIG. 3 depicts an illustration of a device showing a cleaning page, according to at least some embodiments disclosed herein;

FIG. 3A depicts an illustration of a device showing a cleaning page, according to at least some embodiments disclosed herein;

FIG. 3B depicts an illustration of a device showing a cleaning page, according to at least some embodiments disclosed herein;

FIG. 4 depicts an illustration of a device showing a cleaning materials page, according to at least some embodiments disclosed herein;

FIG. 4A depicts an illustration of a device showing a cleaning materials page, according to at least some embodiments disclosed herein;

FIG. 5 depicts an illustration of a device showing a cleaning page, according to at least some embodiments disclosed herein;

FIG. 5A depicts an illustration of a device showing a cleaning page, according to at least some embodiments disclosed herein;

FIG. 5B depicts an illustration of a device showing a cleaning page, according to at least some embodiments disclosed herein;

FIG. 5C depicts an illustration of a device showing a cleaning page, according to at least some embodiments disclosed herein;

FIG. 6 depicts an illustration of a device showing a disinfecting page, according to at least some embodiments disclosed herein;

FIG. 6A depicts an illustration of a device showing a disinfecting page, according to at least some embodiments disclosed herein:

FIG. 6B depicts an illustration of a device showing a disinfecting page, according to at least some embodiments disclosed herein;

FIG. 7 depicts an illustration of a device showing a disinfecting materials page, according to at least some embodiments disclosed herein;

FIG. 7A depicts an illustration of a device showing a disinfecting materials page, according to at least some embodiments disclosed herein;

FIG. 8 depicts an illustration of a device showing a disinfecting page, according to at least some embodiments disclosed herein;

FIG. 8A depicts an illustration of a device showing a disinfecting page, according to at least some embodiments disclosed herein;

FIG. 8B depicts an illustration of a device showing a disinfecting page, according to at least some embodiments disclosed herein;

FIG. 8C depicts an illustration of a device showing a disinfecting page, according to at least some embodiments disclosed herein:

FIG. 9 depicts an illustration of a device showing a particulate counts page, according to at least some embodiments disclosed herein;

FIG. 9A depicts an illustration of a device showing a particulate counts page, according to at least some embodiments disclosed herein;

FIG. 9B depicts an illustration of a device showing a particulate counts page, according to at least some embodiments disclosed herein;

FIG. 9C depicts an illustration of a device showing a particulate counts page, according to at least some embodiments disclosed herein;

FIG. 9D depicts an illustration of a device showing a particulate counts page, according to at least some embodiments disclosed herein;

FIG. 10 depicts an illustration of a device showing a particulate counts fail page, according to at least some embodiments disclosed herein;

FIG. 10A depicts an illustration of a device showing a particulate counts page, according to at least some embodiments disclosed herein;

FIG. 10B depicts an illustration of a device showing a particulate counts page, according to at least some embodiments disclosed herein;

FIG. 10C depicts an illustration of a device showing a particulate counts page, according to at least some embodiments disclosed herein:

FIG. 10D depicts an illustration of a device showing a particulate counts page, according to at least some embodiments disclosed herein:

FIG. 11 depicts an illustration of a device showing a particulate counts cancel page, according to at least some embodiments disclosed herein;

FIG. 11A depicts an illustration of a device showing an internal equipment list page, according to at least some embodiments disclosed herein;

FIG. 12 depicts an illustration of a device showing a particulate counts page, according to at least some embodiments disclosed herein;

FIG. 12A depicts an illustration of a device showing a particulate counts page, according to at least some embodiments disclosed herein;

FIG. 12B depicts an illustration of a device showing a particulate counts page, according to at least some embodiments disclosed herein;

FIG. 12C depicts an illustration of a device showing a particulate counts page, according to at least some embodiments disclosed herein;

FIG. 12D depicts an illustration of a device showing a particulate counts page, according to at least some embodiments disclosed herein:

FIG. 13 depicts an illustration of a device showing a particulate counts page, according to at least some embodiments disclosed herein;

FIG. 13A depicts an illustration of a device showing a particulate counts page, according to at least some embodiments disclosed herein:

FIG. 13B depicts an illustration of a device showing a particulate counts page, according to at least some embodiments disclosed herein;

FIG. 13C depicts an illustration of a device showing an internal equipment list page, according to at least some embodiments disclosed herein;

FIG. 14 depicts an illustration of a device showing a microorganism page, according to at least some embodiments disclosed herein;

FIG. 14A depicts an illustration of a device showing a microorganism page, according to at least some embodiments disclosed herein;

FIG. 14B depicts an illustration of a device showing a microorganism page, according to at least some embodiments disclosed herein;

FIG. 14C depicts an illustration of a device showing a microorganism page, according to at least some embodiments disclosed herein;

FIG. 14D depicts an illustration of a device showing a microorganism page, according to at least some embodiments disclosed herein:

FIG. 14E depicts an illustration of a device showing a microorganism page, according to at least some embodiments disclosed herein;

FIG. 14F depicts an illustration of a device showing a microorganism page, according to at least some embodiments disclosed herein;

FIG. 15 depicts an illustration of a device showing a charts page, according to at least some embodiments disclosed herein;

FIG. 15A depicts an illustration of a device showing a charts page, according to at least some embodiments disclosed herein;

FIG. 15B depicts an illustration of a device showing a charts page, according to at least some embodiments disclosed herein;

FIG. 15C depicts an illustration of a device showing a charts page, according to at least some embodiments disclosed herein;

FIG. 15D depicts an illustration of a device showing a charts page, according to at least some embodiments disclosed herein;

FIG. 15E depicts an illustration of a device showing a charts page, according to at least some embodiments disclosed herein;

FIG. 16 depicts an illustration of a device showing a logs page, according to at least some embodiments disclosed herein;

FIG. 16A depicts an illustration of a device showing a logs page, according to at least some embodiments disclosed herein;

FIG. 16B depicts an illustration of a device showing a logs page, according to at least some embodiments disclosed herein;

FIG. 16C depicts an illustration of a device showing a logs page, according to at least some embodiments disclosed herein;

FIG. 17 depicts an illustration of a device showing a room selection page, according to at least some embodiments disclosed herein;

FIG. 17A depicts an illustration of a device showing a frame page, according to at least some embodiments disclosed herein;

FIG. 18 is a flowchart illustrating computer-implemented method for automated validation for clean room certification, according to some embodiments of present disclosure;

FIG. 19 is a block diagram illustrating a system, according to some embodiments of the present disclosure;

FIG. 20 depicts an illustration of a device showing a pest control workflow, according to at least some embodiments disclosed herein;

FIG. 21 depicts an illustration of a device showing a water workflow, according to at least some embodiments disclosed herein;

FIG. 22 depicts an illustration of a device showing an air filter workflow, according to at least some embodiments disclosed herein;

FIG. 23 depicts an illustration of a device showing a fire extinguishers workflow, according to at least some embodiments disclosed herein; and

FIG. 24 depicts an illustration of a device showing a pressure differentials workflow, according to at least some embodiments disclosed herein.

### DESCRIPTION OF THE PREFERRED EMBODIMENTS

The preferred embodiments of the present invention will now be described with reference to the drawings. Identical elements in the various figures may be identified with the same reference numerals. Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto. As used herein, the singular forms “a.” “an,” and “the,” are intended to include the plural forms as well, unless the context clearly indicates otherwise. The phrase “and/or,” as used herein in the specification and in the claims, should be understood to mean “either or both” of the elements so conjoined, i.e., elements that are conjunctively present in some cases and disjunctively present in other cases. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The cleanroom certification app offers a comprehensive set of features aimed at ensuring strict adherence to cleanliness standards. It enables recording and management of approved supplies and equipment, facilitating easy access to authorized items. With automatic display capabilities, it streamlines the process of identifying approved supplies and equipment. App allows admins to set up users and provides 24/7 cloud-based access. Defined procedures are integrated to minimize infection risks, including recording cleaning and disinfecting activities. An automated audit log tracks all activities for accountability. The app also allows for recording of particle counts, temperature, humidity, air changes per hour, and pressure differentials. It includes an internal database of ISO standards and automatically determines pass/fail status for particles and microorganisms. Notifications keep users informed about open jobs and activities, while generated charts provide visual insights into particle and microorganism data. Data can be exported electronically in printed or PDF format, and app is designed for scalability to accommodate more users and rooms. Finally, verification of all work activities ensures thoroughness and compliance with standards.

The app boasts features designed to streamline various certification process aspects. Among these, the environment setup facilitates database and NodeJS configuration, ensuring seamless operation. App provides tools for XCode project setup, Bit Bucket, and SourceTree integration. Schema design aligns with SAAS models, and options for API hosting are available. Authentication mechanisms and SMS/OTP functionalities can be customized as per requirements. Features include, but are not limited to, cleaning, disinfecting, particulate count monitoring, and microorganism analysis. Functionalities encompass record insertion, data retrieval, screen design, and logic programming. App leverages iOS caching mechanisms for data management and provides APIs for accessing and saving relevant information. It offers chart generation, log retrieval, and user management, including administrative screens and payment functions. The backend API, built on NodeJS, supports various operations, including user management, room and equipment handling, cleaning, disinfecting, particulate count recording, chart data retrieval, and microorganism analysis. These features contribute to a robust and user-friendly solution for cleanroom certification.

In implementations, the cleanroom certification app offers features enabling efficient management and operation of a certification process. Clients can communicate desired number of rooms and users, with the total price dynamically adjusting based on these parameters. Upon payment, client receives a code enabling them to download a web version of the app. Twilio integration provides one-time passwords for user authentication. Dashboard allows admin to manage users within the paid limit, with options to preselect desired user numbers and invite new users manually via email invitations. Users and clean rooms can be added or removed within the paid limit, with the ability to convert users to admins. Adding or removing users affects the recurring monthly cost accordingly. The app enables admins to enter cleanroom names and users, with mandatory cleanroom titles and a historical trail for edited titles. Admins can register users with unique credentials, inviting new users manually after initial onboarding. Facial recognition or biometrics can be used for authentication, with optional or mandatory settings. The app supports admin input of cleaning and disinfecting supply names, with options to add, remove, or edit products. Admins can choose ISO classifications for rooms, dual-classify rooms, and configure the number of plates used per room. Users can input text descriptions and record maximum and minimum organisms per location for compliance. Admins can enter minimum air changes required for each room, with transactional data recorded in an un-editable audit log.

As noted, in at least one embodiment, admins can review audit logs, download them into PDF files, and register specific tablets as authorized devices up to the number of paid users. Users can access app through unique logins, with restrictions on concurrent logins. App offers menu-driven navigation and notifications for open tasks, with automated notifications based on completion status. Users can navigate between screens for cleaning, disinfecting, particle counts, microorganisms, charts, audit logs, and sign-out. Transactional data must be verified by managers before being saved, with options for acceptance or rejection. Particle count screens facilitate data entry and real-time calculation, with pass/fail checks based on admin-set criteria. Microorganisms can be recorded, with options to enter organism details and pass/fail determinations. Audit logs record completed transactions, with download and email options. Charts provide visual representations of data, with options to download, screenshot, or email. App features timeout mechanism and supports operation on iOS and Windows/Android systems, preferably tablets and mini-tablets, using Flutter SDK.

Further, in implementations, the cleanroom certification app offers features to ensure efficient management and monitoring of cleanroom facilities. Users are provided with login credentials assigned by the admin, facilitating secure access to the platform. In case of forgotten passwords, users can retrieve them through the admin, ensuring data integrity and security. During signup, essential details such as facility name, address, contact information, and the number of cleanrooms are entered, with additional fields completed post-payment. The app supports fingerprint or facial recognition for convenient login, with manual options available for older device versions. The onboarding process includes device registration by the admin and a training program to familiarize users with the app functionalities, backed by customer support for any queries. The dashboard presents a user-friendly menu for navigation, with task lists, room assignments, and notifications highlighted on the welcome page. Room details, including location, tasks, microorganism identification, and approved agents, are meticulously documented, ensuring thorough cleanliness protocols.

In some embodiments, cleaning and disinfecting activities are streamlined through drop-down lists of approved agents and materials, preventing unauthorized usage. Batch numbers and room specifications further enhance accountability and efficiency. Notifications prompt users to complete open tasks, ensuring timely completion and adherence to protocols. Particulate count features incorporate NIST traceable equipment registration and detailed specifications per activity level, empowering users to maintain optimal cleanroom conditions. Microorganism monitoring encompasses basic record-keeping, incubation periods, and plate information, with notifications facilitating timely plate reading by microbiologists. Charts provide insightful data visualization, while logs track work activity and export history for accountability and analysis. Settings allow users to customize accessibility, notifications, and preferences, ensuring a seamless user experience tailored to individual needs. With its comprehensive features and user-friendly interface, the cleanroom certification app offers a robust solution for managing cleanroom facilities efficiently.

The cleanroom certification app will streamline cleanroom management processes. Admins are provided with secure login credentials, with options for password retrieval via email in case of forgetfulness. Signup processes include two-step verification for security, ensuring only authorized platform access. Advanced login methods such as facial recognition or fingerprint are supported for user convenience. Onboarding process includes tutorials for admins/managers, empowering them to efficiently train users. Application subscriptions can be ordered through the platform's website, with verification processes ensuring secure access. Dashboard provides intuitive navigation, with customizable menus allowing admins to establish and enforce rules within ISO classes. Welcome page facilitates seamless communication between admins and users, with task lists and room assignments displayed.

In some embodiments, rooms can be easily managed, with options to add, delete, or edit details as needed. Microbial plate information, ISO classifications, and air change calculations are meticulously documented to ensure adherence to cleanliness standards. Cleaning and disinfecting protocols are streamlined through drop-down lists of approved agents and materials, with options to add or delete agents as needed. Equipment management features enable admins to track internal and external equipment usage, ensuring compliance with calibration schedules and particle counting requirements. Strong charting functionalities provide insightful analytics and export capabilities, while detailed logs track work activity and user interactions. Employee management tools allow admins to create and manage user profiles, ensuring efficient scheduling and communication within the organization. Settings offer customizable accessibility and preference options, further enhancing user experience.

The Clean Spaces App management flow revolves around aiding users and administrators (admins) in efficiently managing the cleaning and disinfecting of company rooms. Admins sign up users by inputting necessary details such as facility information, cleanroom classifications, and approved supplies. Users then sign in using provided credentials, undergoing training before accessing the main dashboard. Password retrieval options are available in case of login issues. Registered devices, designated by the admin, ensure seamless access to the Clean Spaces App. The dashboard notifies users of assigned tasks, which they can view and manage within the app. Lack of tasks prompts users to contact admins. Upon signing in, users are directed to a menu-driven page offering various options including cleaning, disinfecting, and accessing audit logs. This comprehensive system facilitates effective management of cleanroom certification tasks.

In the cleanroom certification app, users are promptly informed of pending tasks, including open work orders, micro plate counts, and any other critical unfinished tasks or rejected verifications from managers. Notifications are provided upon each login and can be accessed through a bell icon on the screen. When selecting the cleaning option from the menu, users are seamlessly directed to the cleaning/disinfecting screen. In Milestone 4, users can select specific locations within a room for cleaning or disinfecting from a checkbox list provided by the admin. Additionally, in Milestone 5, users can choose the room to clean/disinfect from a drop-down list and specify the frequency of cleaning. They can also select cleaning substances from a drop-down menu preloaded by the admin, recording substance-specific details such as strength, PIN, lot number, and expiration date. Users have the flexibility to cancel transactions or save them for later completion. Furthermore, the app allows users to generate unique batch numbers for cleaning/disinfecting materials and record details of hardware or materials used. In Milestone 6, users can access the Particle Counts screen from the main menu, choosing between internal or external particle counting equipment. If internal equipment is chosen, users select from a drop-down list of approved equipment. They can also choose multiple pieces of equipment for room qualification and enter details for external equipment. Finally, users are provided with options to proceed to the next step or cancel selection, ensuring smooth navigation through the app's features.

In the cleanroom certification app, users have a streamlined process for recording room classifications and particle sizes. Upon navigating to the Particle Count screen, users can select room classifications and choose particle size to be recorded. After inputting particle size data, users are guided through screens where they can enter numbers for each particle size, with real-time calculations for standard deviation, average, and 95% UCL. The app automatically compares the calculated 95% UCL against admin inputs, determining pass or fail status. Also, users can input room air change numbers, with validation against admin inputs. In Milestone 7, users can select specific rooms for micro plate usage and start a timer for incubation. Transactions can be saved as open transactions for future inputs. Incomplete transactions prompt notifications until completed. Milestone 9 introduces audit logs accessible from the main menu, where users can view and download/email transaction details, with no option for editing or deletion. Users can take screenshots within audit log screens and return to the main menu. Charts can be accessed from the main menu, with options to view particle counts and micro charts, choose specific rooms and particle counts, and download, email, or screenshot charts. App ensures user continuity, returning users to the last screen upon timeout, and is compatible with iOS and Windows/Android systems.

The app is a tool for admins and managers to oversee cleaning and disinfection of rooms within a company. Admins can manage room assignments, user registrations, and supply inputs. During signup, admins provide essential details like company logo, user information, and payment preferences. After successful signup, admins undergo an onboarding process, including tutorials, and access the app via unique credentials. They can register cleanrooms and users, assigning unique usernames and passwords.

In another embodiment, admins can specify the number of contact, settle, and impact plates per room, record maximum organism levels, and input minimum air changes required for each room. The app facilitates input of cleaning and disinfecting supplies, choice of room classification, and registration of specific tablets for authorized device use. Managers, on the other hand, utilize the app to verify user tasks before closing tickets. Upon completion of tasks, users notify managers for verification. Managers can then accept or reject transactions, with rejected transactions generating a note section for additional information. They also have the option to turn off verifications and receive notifications of incomplete transactions in case of device shutdown during work. Overall, the app ensures efficient management of cleaning processes with clear oversight and verification mechanisms.

In an embodiment, SignUp/Login encompasses several key features. Upon first downloading the app, the admin is prompted to create an account (SignUp) by providing essential details like email, phone number, and password. Subsequently, a verification process is initiated to confirm the admin's email/phone number. For existing users, Sign-in option allows access using established credentials. In case of a forgotten password, a reset option (Forget Password) sends an email or text containing a verification code for password reset instructions. The app also offers biometric authentication options such as fingerprint or face recognition for quicker login, particularly beneficial for newer iPad models.

In another embodiment, dashboard functionalities include account management, where admins can upload profile pictures and edit personal information like first name, last name, email, password, phone number, and address. Status of accounts can also be viewed and modified. User Management tools enable admins to categorize users by type (Admin or User), search for specific users by name, and sort or filter user lists alphabetically. The feature allows the addition of new system users. Notification Management allows admins to create, view, and schedule notifications, both manually and automatically, ensuring effective communication within the system. Another embodiment focuses on User Management, providing detailed insights into user and admin profiles. Admins can access and modify user details such as facility name, address, contact number, contact person (admin), company name, and status (User/Admin). Similarly, admin details can be edited or deleted as needed. These features offer comprehensive control over user and admin information.

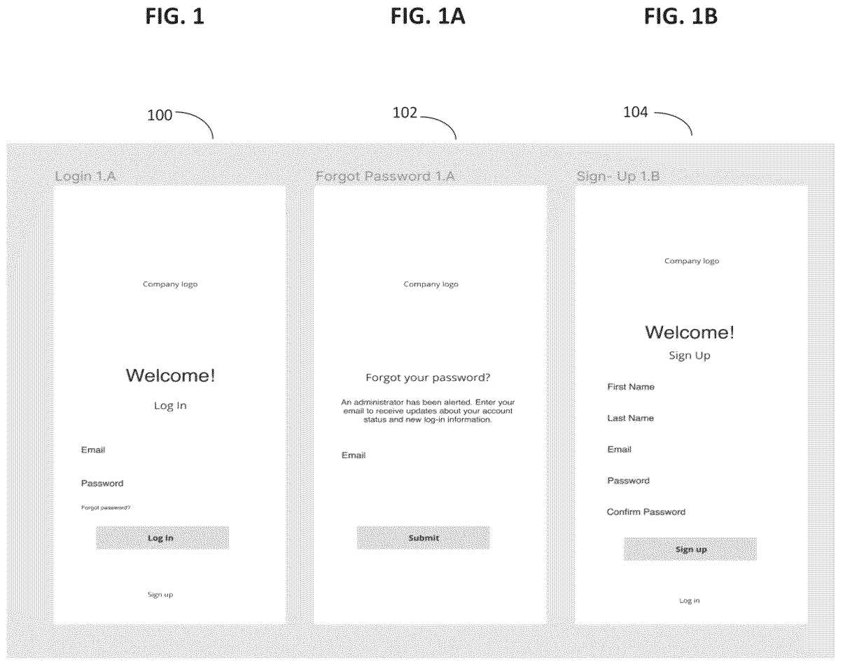

FIG. 1 depicts an illustration of a device showing an operational sequence for logging into an account of the program. At 100, the login procedure is performed with an icon for Email, Password, and/or Forget Password. Any electronic device having a screen and a user interface, for example, may facilitate this process to transpire. Login information is assigned to the users by the admin. The admin will be able to login using the username and password.

FIG. 1A depicts an operational sequence for resetting a password associated with an account of the program. At 102, the login procedure is performed to alert an admin that a password has been forgotten and the password retrieval process occurs. Admin has the passwords of the users. If the user forgets the password, they should go to the admin and ask for it. An email will be sent to the admin with instructions on how to reset password.

FIG. 1B depicts an illustration of a device showing an operational sequence for signing up for a program account. At 104, the onboarding process is performed to Sign Up having (Name, Email, Password, Two-Step Verification). When the user first downloads the app, the user should sign up. Or when there is a new employee, the admin should sign up the new employee. This information will be on the app or website. Facility, contact person, number of cleanrooms and number of users should be entered prior to paying. Other fields should be filled in after payment. Sign up data includes, but is not limited to, facility name, address, contact number, contact person (admin) and title, the amount of cleanrooms they have, Unique identifier for each room, classification of each cleanroom, locations within any cleanroom to be cleaned and disinfected, micro testing CFU (colony forming units) limits per cleanroom and per location, listing of all approved cleaning supplies, listing of all approved disinfecting supplies, microbial limits for each room, and/or the number of users or users they have. It is within the scope of this invention for a user to be allowed to set up a fingerprint and/or a facial recognition identification depending on the electronic device used. For example, an iPad having a newer version for a faster login. If the iPad is an older version, then manual signing in is required. Admin will be able to sign up themselves and their users.

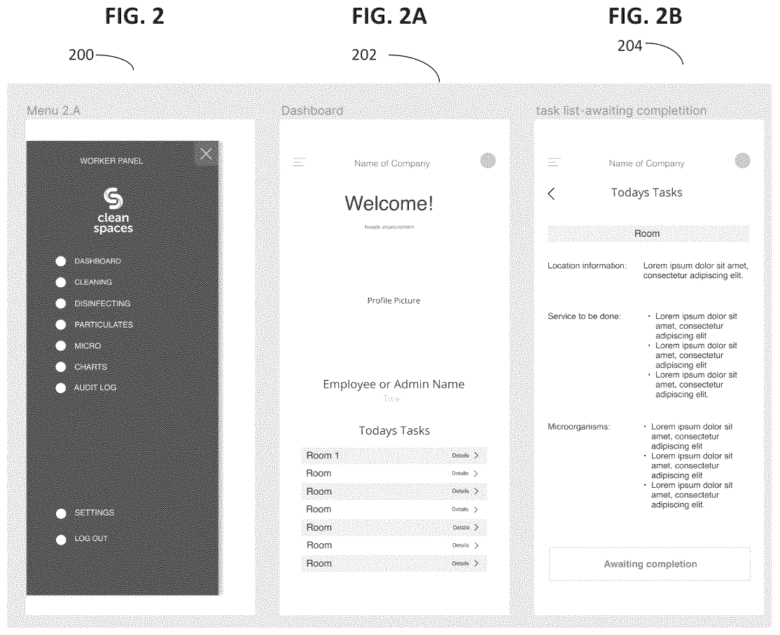

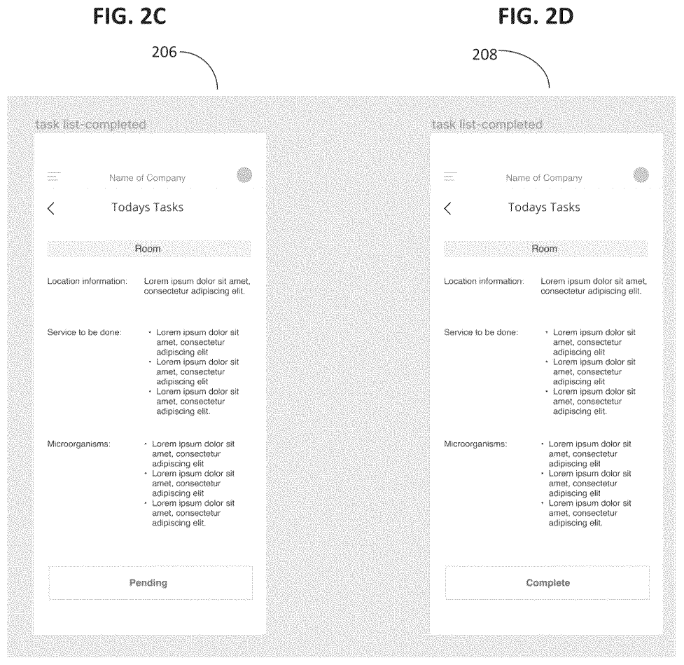

FIG. 2 depicts an illustration of a device showing a menu page of the program. At 200, menu has icons for a Dashboard, Cleaning. Disinfecting, Particulates, Micro, Charts, Audit Log, Settings, and Log Out, according to at least some embodiments disclosed herein. The admin would register a device for each user. Users are trained on the app by admin. If any questions arise, new users can ask customer support. The tutorial will only be given to admins and managers. The admins train users. Admins can order their subscription from the app website. Once information is verified, a link would be sent to an admin database. If the app is made public on the app store, the admins would need to be granted access.

FIG. 2A depicts an illustration of a device showing a dashboard having a welcome page of the program. At 202, the Welcome Page has a tab for User Profile, Task Lists, and Room Assignments, according to at least some embodiments disclosed herein. The menu is where the user navigates to the different components of the app. When and where to disinfect/clean should be the facility's choice. This will be noted in the calendar. The menu has an icon for Dashboard, Cleaning, Disinfecting, Particulates, Micro, Charts, Audit Log, Settings, Log Out, and/or Calendar. Every time the user logs in, the admin should notify the user on any new tasks in the task list and all open tickets. When a ticket is closed, it should not be visible in the task list. User tasks are assigned by the admin/company. Users are not able to make any changes to assigned duties within the app. User will get a notification every time a ticket is open or rejected or if it is time to read micro plates. There will be no “pre-build” book per ISO class. The admin controls and establishing rules within the ISO class. When a user logs in, the admin should notify the worker of any open tickets.

FIG. 2B depicts an illustration of a device showing a task list awaiting completion. At 204, Room Details are shown including a Task List and a Room Status. Room data includes, but is not limited to, location, service to be performed, and/or microorganism to be detected and/or detected according to at least some embodiments disclosed herein. When any new room is added or a room is not used anymore in the company, the admin can add and delete rooms in the list respectively. Admin can enter room details when adding a new room to the list such as the location in the room that needs to be cleaned. Admin will decide what areas of the room are cleaned and disinfected (locations drop-down list). Tasks that need to be completed by the user in the assigned room will be indicated in the Tasks to be completed section. Microorganism at each location to be identified by admin. The Agents (Cleaning and Disinfecting) tab is where the cleaning and/or disinfecting agents are listed.

FIG. 2C depicts an illustration of a device showing a pending task list completed page. At 206, Room Details are shown including a Task List and a Room Status. Room data includes, but is not limited to location, service to be performed, and/or microorganism to be detected and/or detected according to at least some embodiments disclosed herein;

FIG. 2D depicts an illustration of a device showing a complete task list completed page. At 208, room details are shown including a task list and room status. Room data includes, but is not limited to location, service to be performed, and/or microorganism to be detected and/or detected according to at least some embodiments disclosed herein;

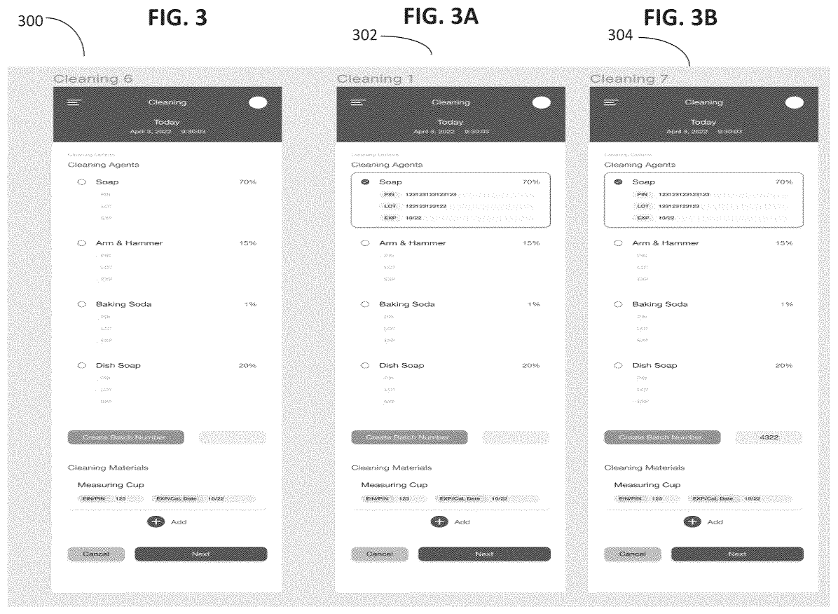

FIG. 3 depicts an illustration of a device showing a cleaning page. At 300, the cleaning page displays cleaning agent data including, but not limited to, Soap, Arm & Hammer, Baking Soda, and/or Dish Soap. A batch number for cleaning and disinfecting can be shown. A list of cleaning materials including, but not limited to, a measuring cup is displayed on the user interface of the program as well as different agents used for the cleaning and disinfecting the location. Admin or Quality Assurance (QA) puts the approved cleaning/disinfecting agents in a drop-down list so user can choose the most applicable from the list. Admin creates different drop-down lists for cleaning and disinfecting agents so that the user, such as, an employee, does not use the disinfecting agent for cleaning and vice-versa. User does not have the privilege to add or delete agents from drop-down lists. User is not allowed to enter any data of their cleaning and disinfecting until after all work is done. The ticket can be opened and user can input data as they finish. User must input lot number and expiration date of the approved agents chosen from drop-down list. After choosing “cleaning” the user will be directed to another menu where they choose the room to clean. Once the room is chosen, all information is automatically added.

FIG. 3A depicts an illustration of a device showing a cleaning page. At 302, cleaning page displays cleaning agent data that includes, but is not limited to, Soap, Arm & Hammer, Baking Soda, and/or Dish Soap. Cleaning agent selected is Soap. Pin, Lot, and EXP date shown. Batch number can be shown. Batch number data refers to type of material and/or instrument used as the agent. Admin or QA inputs approved materials in a drop-down list they create and user chooses from the list. User has the option to select all. A list of cleaning materials including, but not limited to, a measuring cup is displayed on user interface of the program. User will receive notifications if a ticket was opened, but a task was not completed. As a result, further data would be required to finish the ticket.

FIG. 3B depicts an illustration of a device showing a cleaning page. At 304, the cleaning page displays cleaning agent data that includes, but not limited to, Soap. Arm & Hammer, Baking Soda, and/or Dish Soap. Cleaning agent selected is Soap. Batch number 4322 for cleaning and disinfecting is shown. A list of cleaning materials including, but not limited to, a measuring cup is displayed on the user interface of the program. Admin or QA inputs approved materials in a drop-down list they create and user chooses from the list. There are different drop-down lists for cleaning and disinfecting agents so user does not use disinfecting agents for cleaning and vice-versa. Admin can add cleaning/disinfecting agents as required. The type of material or instrument used for the agent. User has the option to select all. Admin can send notifications to user when a ticket is open and requires data entry.

Cleaning agents are entered by the user, including their Product Identification Number (PIN), Lot Number (LOT), and Expiration Date (EXP). App features a batch system where users can select existing batches for new cleaning products, accessing a shared database among all companies using the app. If an inputted batch number does not exist, an ERROR message in red alerts the user. Creating a new batch prompts a random 4-digit PIN (starting from “0001”), linking back to the cleaning agents page for association. Batch is only finalized into the system upon saving. The “ADD” button allows users to include additional cleaning materials via PIN and EXP. During cleaning, a waiting screen or pop-up indicates activity, with users returning to this screen afterward. Saving preserves user inputs without updating the official audit log, enabling users to resume from the next page if logged out, with the option to edit and save again.

Users are guided through prompts presented in a pop-up interface where they input essential details like PIN, LOT, and EXP, along with “Temperature” and “Humidity” parameters. Another pop-up facilitates addition of extra cleaning materials, allowing users to input any necessary materials. Admin-configured pop-up screens enable users to select their current room and location, ensuring accuracy in reporting. Also, users can input comments via a textbox within the app if any issues need to be brought to the attention of the manager.

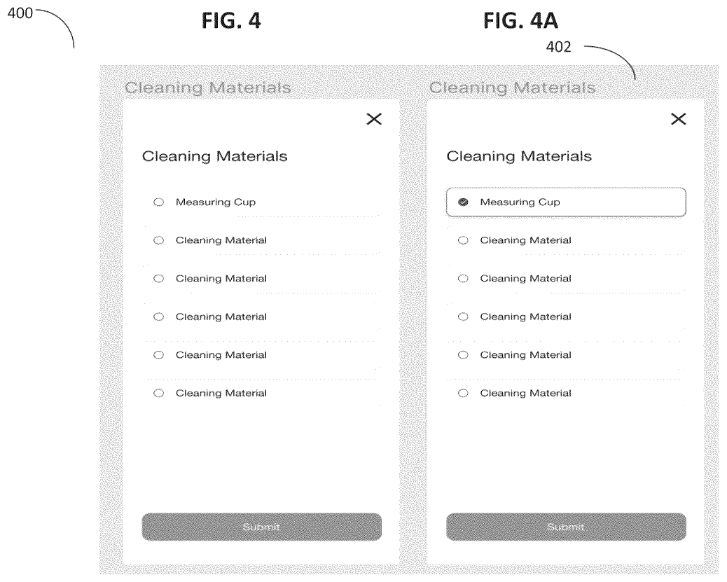

FIG. 4 depicts an illustration of a device showing a cleaning materials page. At 400, a list of cleaning materials including, but not limited to, a measuring cup and/or various other cleaning materials are displayed on the user interface of the program.

FIG. 4A depicts an illustration of a device showing a cleaning materials page. At 402, a measuring cup is selected from a list of cleaning materials displayed on the user interface of the program.

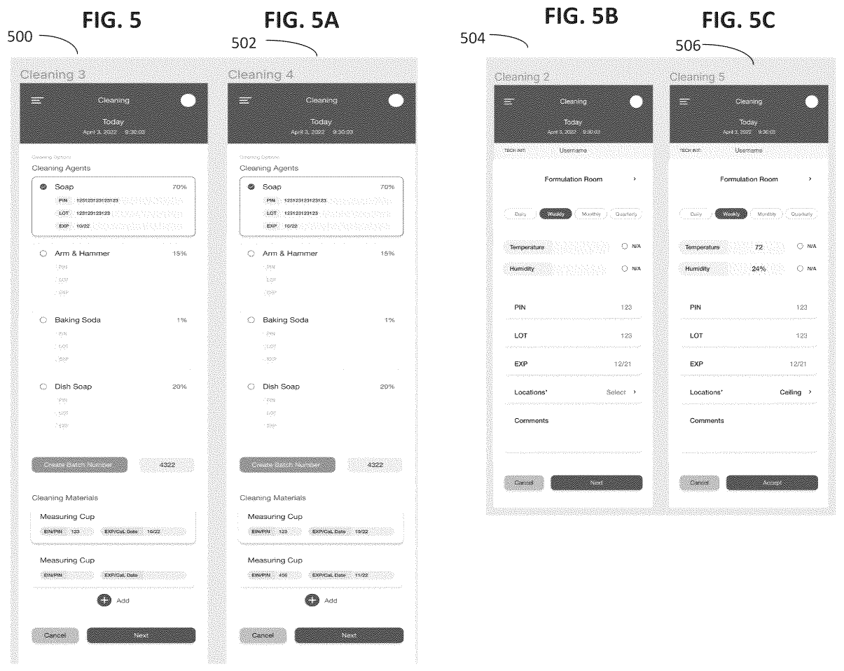

FIG. 5 depicts an illustration of a device showing a cleaning flow page. At 500, a cleaning agent has Soap selected, having batch number 4322 with cleaning material being a measuring cup having EIN/Pin No. 123 and EXP/Cal. Date 10/22.

FIG. 5A depicts an illustration of a device showing a cleaning flow page. At 502, a cleaning agent has Soap selected, having batch number 4322 with cleaning material being a measuring cup having EIN/Pin No. 123 and EXP/Cal. Date 10/22. A second measuring cup has EIN/Pin No. 456 and EXP/Cal. Date 11/22.

FIG. 5B depicts an illustration of a device showing a cleaning flow page. At 504, a formulation room is selected for weekly. Icons for temperature and humidity value are displayed to a user. The PIN, LOT, EXP, Location, and Comment field is displayed to a user.

FIG. 5C depicts an illustration of a device showing a cleaning flow page. At 506, a formulation room is selected for weekly. The icon for temperature displays 72 and the icon for humidity displays 24% are displayed to a user. The PIN, LOT, EXP, Location, and Comment field is displayed to a user. The Location icon states “Ceiling.”

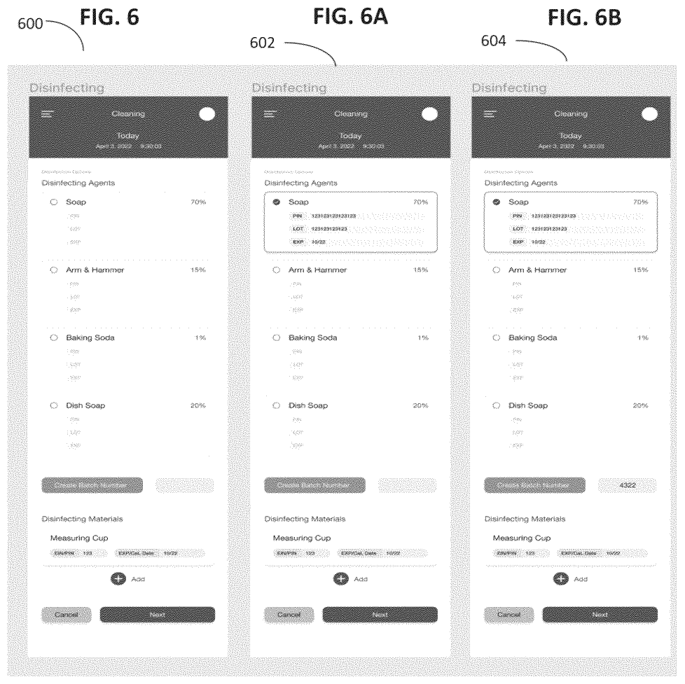

FIG. 6 depicts an illustration of a device showing a disinfecting flow page. At 600, disinfecting agent data includes, but is not limited to, Soap, Arm & Hammer, Baking Soda, and/or Dish Soap. An icon for receiving an input value of a batch number for disinfecting is shown. A list of disinfecting materials including, but not limited to, a measuring cup is displayed on the user interface of the program. Upon selecting a disinfecting agent, users are prompted to input the PIN, LOT, and EXP numbers. If a batch number that does not exist is entered, an ERROR message appears in red, indicating that the batch does not exist. Also, the “Create batch number” function generates a random 4-digit PIN number, linking it back to the cleaning agents page for batch number association. The “Materials” tab opens another screen where users can add additional materials via a pop-up interface. A waiting screen or pop-up is implemented to indicate that the user is in the process of cleaning, with a return to the main screen after completion. Saving inputs stores user data without updating the official audit log, allowing users to continue from the same point even after logging out. For additional materials, users are provided with a pop-up screen to select and input the LOT and EXP date for materials they are utilizing. Room selections are facilitated by admin, enabling users to choose their current room and disinfecting locations through pop-up screens.

FIG. 6A depicts an illustration of a device showing a disinfecting flow page. At 602, the disinfecting agent selected is Soap having the PIN, LOT and EXP information displayed. An icon for receiving an input value of a batch number for disinfecting is shown. A list of disinfecting materials including, but not limited to, a measuring cup is displayed on the user interface of the program.

FIG. 6B depicts an illustration of a device showing a disinfecting flow page. At 604, the disinfecting agent selected is Soap having the PIN, LOT and EXP information displayed. The batch number for disinfecting is shown to be 4322. A disinfecting materials list including, but not limited to, a measuring cup is displayed on the program user interface.

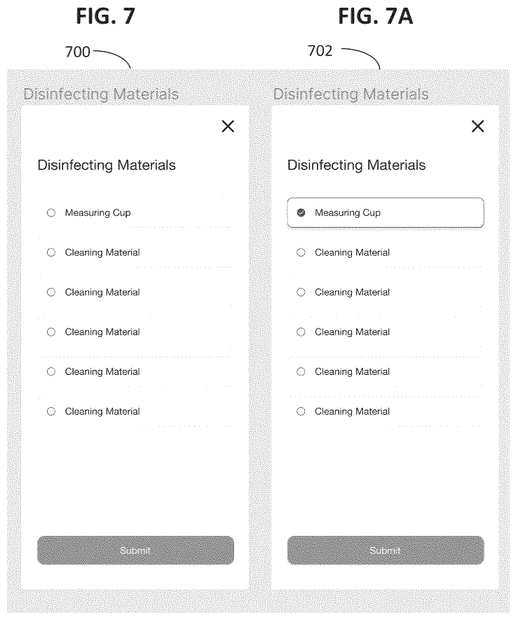

FIG. 7 depicts an illustration of a device showing a disinfecting materials page. At 700, a list of disinfecting materials includes, but is not limited to, a measuring cup.

FIG. 7A depicts an illustration of a device showing a disinfecting materials page. At 702, a list of disinfecting materials includes, but is not limited to, a measuring cup. A measuring cup is selected and displayed to a user.

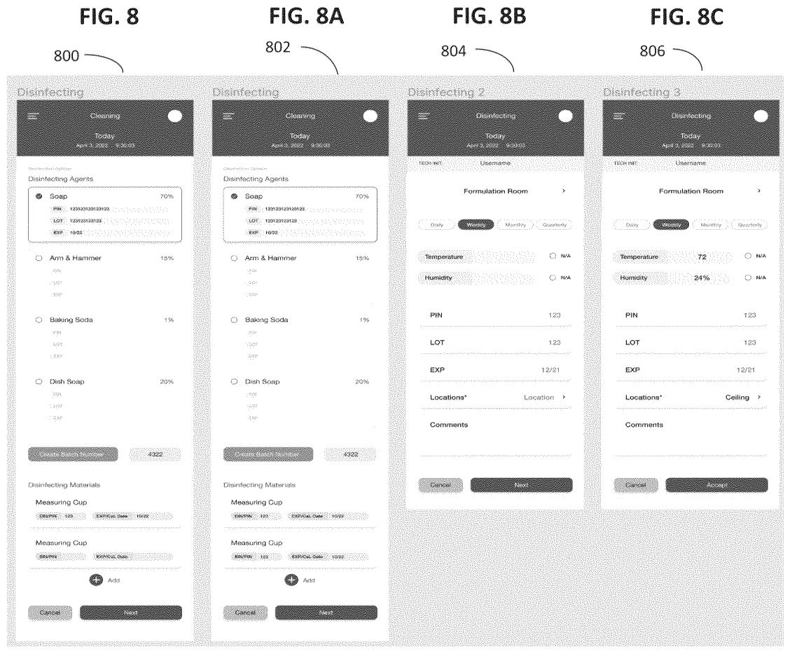

FIG. 8 depicts an illustration of a device showing a disinfecting page. At 800, disinfecting agent, soap is selected with a PIN, LOT, and EXP values. A batch number is displayed. Measuring cups with EIN/PIN and EXP/Cal. Date data is displayed.

FIG. 8A depicts an illustration of a device showing a disinfecting page. At 802, disinfecting agent, soap is selected with a PIN, LOT, and EXP values. A batch number is displayed. Measuring cups with EIN/PIN and EXP/Cal. Date data is displayed.

FIG. 8B depicts an illustration of a device showing a disinfecting page. At 804, a formulation room is selected for weekly. The icon for temperature and the icon for humidity, the PIN, LOT. EXP, Location, and Comment field is displayed to a user.

FIG. 8C depicts an illustration of a device showing a disinfecting page. At 806, a formulation room is selected for weekly. The icon for temperature displays 72 and the icon for humidity displays 24% are displayed to a user. The PIN, LOT, EXP, Location, and Comment field is displayed to a user. The Location icon states “Ceiling.”

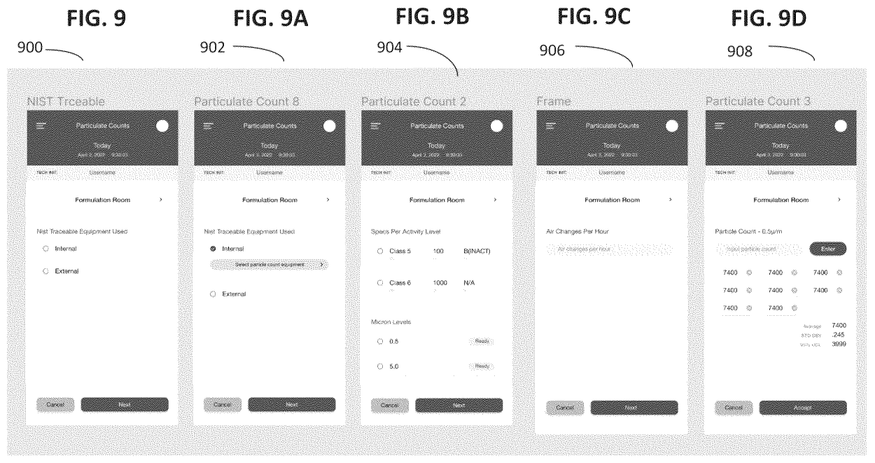

FIG. 9 depicts an illustration of a device showing a particulate counts page. At 900, A Room Selection (Drop-down List) is provided. Formulation room is displayed. NIST Traceable Equipment Registration icons are shown such as, Internal: Equipment was given from the company and External: Equipment was rented out or used from another company. Room selection is facilitated through a drop-down menu input by the admin, offering users a convenient selection method. NIST Traceable Equipment usage is divided into internal and external categories. Internal equipment, such as particle counting machines, is preloaded from the admin panel, with the exception of the Calibration Due Date, which users must select via a date picker. External equipment requires manual entry of details like Model Name, Number, Serial Number, and Cal Due Date, with the latter flagged if expired. The “Name of Equipment” section, now renamed “Equipment in Use,” displays selected internal equipment or remains blank for external equipment, emphasizing commitment to one equipment source. The “Additional Equipment” button opens a list for users to add more equipment. Saving inputs preserves user data without updating the official audit log, allowing for post-save editing and saving. When selecting external equipment, users manually input details like Model Name, Number, Serial Number, and Cal Due Date.

Specifications per activity level and air changes per hour are pulled from admin panel and flagged if outside set limits. Room selection is locked after selection but can be edited if users navigate back, with app storing temporary data locally until key points or stage completion. Formula 1 checks against admin-set limits, failing if below limit. Temperature and humidity can be set as mandatory or optional by admin, with optional mode allowing clickable N/A fields and flagging based on set limitations. Most rooms feature a single ISO Class, but some may be dual-classified, with ISO Classes ranging from ISO 1-9, each with admin-configured micron level options. Users input particle counts based on readings within a range of 1-999,999,999 μm. Particle readings include Average. Standard Deviation, and 95% Upper Confidence Level (UCL), calculated according to Reference Formula 2. “Accept” button is replaced with “Save and continue with next Particle Count” for efficient data entry.

FIG. 9A depicts an illustration of a device showing a particulate counts page. At 902, A Room Selection (Drop-down List) is provided. Formulation room is displayed. NIST Traceable Equipment Registration icons are shown such as, Internal: Equipment was given from the company and External: Equipment was rented out or used from another company. Internal is selected and an icon displays select particle count equipment. When internal equipment is given from the company, user can choose equipment from approved equipment drop-down list. When external equipment is rented out and/or used from another company, user will be required to add information regarding equipment used for the particle counting. For internal equipment, admin will put in the approved equipment in the drop-down list from accessible to the user. When adding new equipment, admin should enter details.

FIG. 9B depicts an illustration of a device showing a particulate counts page. At 904, A Room Selection (Drop-down List) is provided. Specs Per Activity Level (Room Classes: US Measurements, EU Measurements, and Micron levels) are provided. Each room has its own environment and must be treated as a separate business entity.

FIG. 9C depicts an illustration of a device showing a particulate counts page. At 906, A Room Selection (Drop-down List) is provided. Air Changes (The amount of air coming in and out of a clean room. Optional for some companies required by others) is provided.

FIG. 9D depicts an illustration of a device showing a particulate counts page. At 908, A Room Selection (Drop-down List) is provided. Particle Count (Particle calculator, Stats: Average, STD, and 95% UCL Requirement) is provided. If calculated particle count exceeds 95% UCL requirement, admin will be notified that room needs to be cleaned. Admin will note location to be cleaned. A failed particle count does not mean room is not clean. Quality and operations personnel need to look into procedures if any part fails. If the average of the room fails, admin is automatically notified about it. Admins should give a unique identifier for each location so users do not get confused on which room they are cleaning. Admin will decide what areas of the room are cleaned and disinfected (locations drop-down list). Admin should let the users know what tasks are to be completed. The microorganism at each location should be identified by admin. Admin should identify agents to be used for different microorganisms. Admin can add/delete sections to Room Details as required. Particle count is calculated for each cleanroom. This will help admin determine if a room needs cleaning.

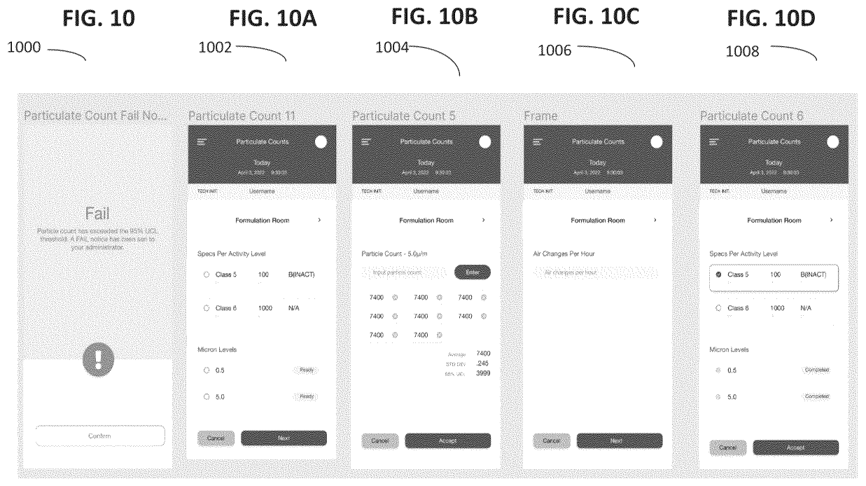

FIG. 10 depicts an illustration of a device showing a particulate counts fail page. At 1000, the particle count has failed when it has exceeded the 95% UCL threshold. A failure notification will alert admin.

FIG. 10A depicts illustration of a device showing a particulate counts page. At 1002, A Room Selection (Drop-Down List) is provided. Specs Per Activity Level (Room Classes: US Measurements, EU Measurements, and Micron levels) are provided.

FIG. 10B depicts illustration of a device showing a particulate counts page. At 1004, A Room Selection (Drop-Down List) is provided. Particle Count (Particle calculator, Stats: Average, STD, and 95% UCL Requirement) is provided.

FIG. 10C depicts illustration of a device showing a particulate counts page. At 1006, A Room Selection (Drop-Down List) is provided. Air Changes (The amount of air coming in and out of a clean room. Optional for some companies required by others) is provided.

FIG. 10D depicts illustration of a device showing a particulate counts page. At 1008, A Room Selection (Drop-Down List) is provided. Specs Per Activity Level (Room Classes: US Measurements, EU Measurements, and Micron levels) are provided. Class 5 selected.

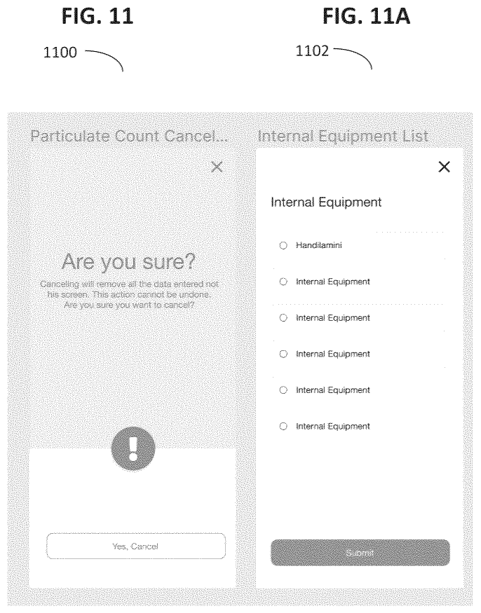

FIG. 11 depicts illustration of a device showing a particulate counts cancel page. At 1100, canceling will remove all the data entered. The action cannot be undone.

FIG. 11A depicts illustration of a device showing internal equipment list page. At 1102, an internal equipment list is displayed. User may make selection and submit webform.

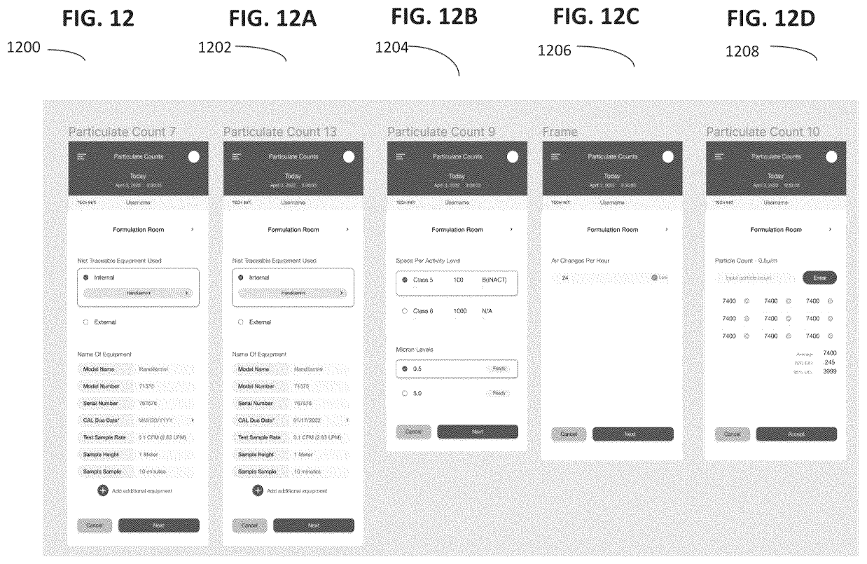

FIG. 12 depicts illustration of a device showing a particulate counts page. At 1200, A Room Selection (Drop-Down List) is provided. Formulation room is displayed. NIST Traceable Equipment Registration icons are shown such as, Internal: Equipment was given from the company and External: Equipment was rented out or used from another company. Internal is selected and an icon displays select particle count equipment. Equipment data includes, but is not limited to, name, model name, model number, serial number, CAL due date, test sample rate, sample height, and/or sample time.

FIG. 12A depicts illustration of device showing particulate counts page. At 1202, A Room Selection (Drop-Down List) is provided. Formulation room is displayed. NIST Traceable Equipment Registration icons are shown such as, Internal: Company equipment and External: Equipment was rented out or used from another company. Internal is selected and an icon displays select particle count equipment. Equipment data includes, but is not limited to, name, model name, model number, serial number, CAL due date, test sample rate, sample height, and/or sample time. In this example, CAL due date is Jan. 17, 2022.

FIG. 12B depicts an illustration of a device showing a particulate counts page. At 1204, A Room Selection (Drop-Down List) is provided. Specs Per Activity Level (Room Classes: US Measurements, EU Measurements, and Micron levels) are provided. Class 5 is selected and micron level 0.5 is selected.

FIG. 12C depicts an illustration of a device showing a particulate counts page. At 1206, A Room Selection (Drop-Down List) is provided. Air Changes (The amount of air coming in and out of a clean room. Optional for some companies required by others) is provided. In this example, there are 24 air changes per hour.

FIG. 12D depicts an illustration of a device showing a particulate counts page. At 1208, A Room Selection (Drop-Down List) is provided. Particle Count (Particle calculator, Stats: Average, STD, and 95% UCL Requirement) is provided.

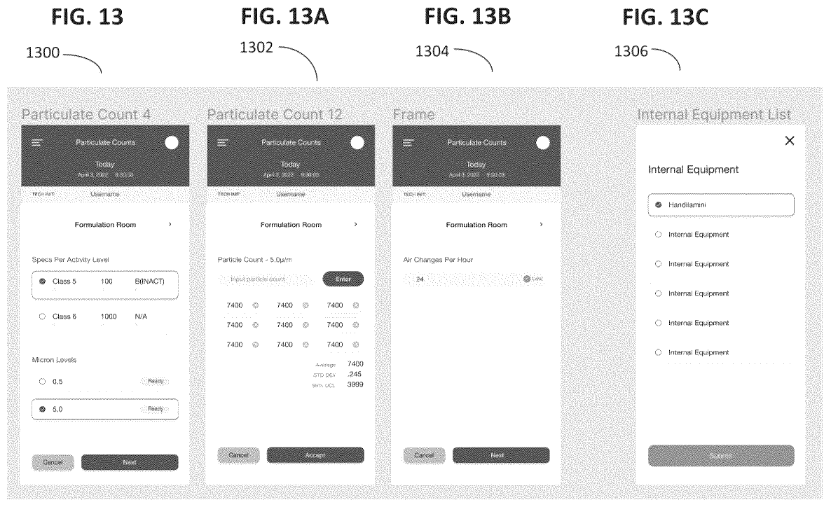

FIG. 13 depicts an illustration of a device showing a particulate counts page. At 1300, A Room Selection (Drop-Down List) is provided. Specs Per Activity Level (Room Classes: US Measurements, EU Measurements, and Micron levels) are provided. Class 5 is selected and 5.0 micro level is selected.

FIG. 13A depicts an illustration of a device showing a particulate counts page. At 1302, A Room Selection (Drop-Down List) is provided. Particle Count (Particle calculator, Stats: Average, STD, and 95% UCL Requirement) is provided.

FIG. 13B depicts an illustration of a device showing a particulate counts page. At 1304, A Room Selection (Drop-Down List) is provided. Air Changes include, but are not limited to, the amount of air coming in and out of a clean room. Optional for some companies-required by others—is provided. In this example, there are 24 air changes per hour. The amount of air coming in and out of a clean room should be calculated and noted by the admin. This will help them determine if a room needs to be cleaned and disinfected. A table with the required minimal air changes per hour per cleanroom can be viewed. The client is not required to record this. Admin can have an option to produce a Pass/Fail result.

FIG. 13C depicts an illustration of a device showing an internal equipment list page. At 1306, internal equipment list is displayed to a user to make selections for submission.

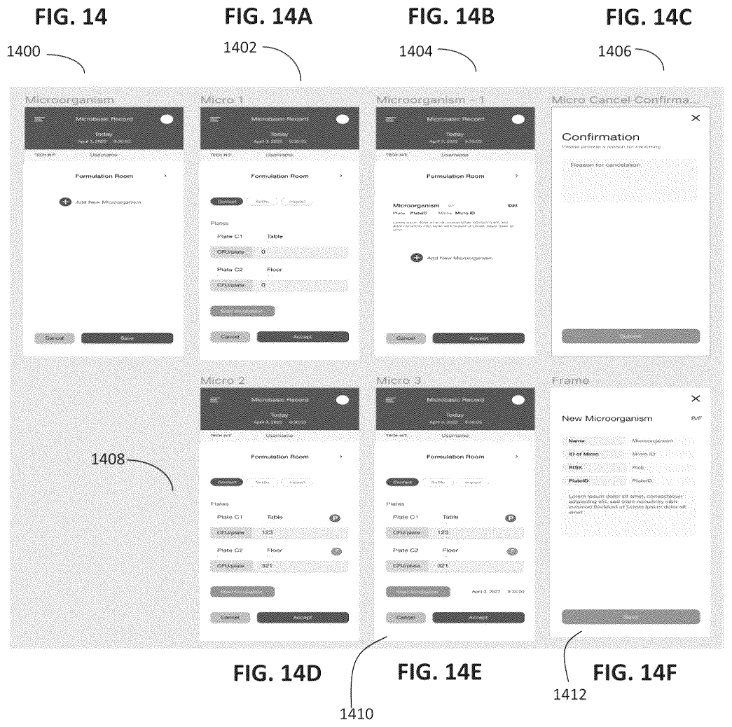

FIG. 14 depicts an illustration of a device showing a microorganism page. At 1400, the Micro-Basic Record page displays a Room Selection (Drop-Down List). Room selection enables users to designate specific rooms within the facility. Plates, categorized as Contact Plates, Settle Plates, and Impact/Aerial Plates, are accessible via buttons and assigned to specific locations by the facility. The Pass/Fail feature employs Algorithm 3, with fail criteria determined by admin-set limitations on colony-forming units (CFU) per plate. Users input CFU/plate values in a designated text box after the incubation timer ends. Initiating incubation starts a timer counting up from “0,” automatically notifying users at the 48-hour and 120-hour marks. Users can submit organism identifications for individual plates, facilitating record-keeping and analysis. A pop-up screen prompts users to select and save plates they wish to add, while another screen facilitates the addition of new microorganisms, including fields for Name, Micro ID, Risk level, Plate ID, and additional information provided by the user. The “Save and Next” button allows users to save information in the audit log and proceed to the next screen seamlessly.

FIG. 14A depicts an illustration of a device showing a microorganism page. At 1402, Micro-Basic Record page (Microbe Type, Plate info, Incubation) displays microorganism plate data and microorganism identification data. A ticket should remain open until plate reading notification. A notification should be sent to read plates. Since users are usually not skilled to read plates, they need to wait for the microbiologist to send report that CPU number has grown. So, microbiologists need to open, save the ticket for reading micro counts, save the ticket for identifying the microorganisms, record the ID, and close the ticket. Microorganism plate information is noted by admin, who should be able to edit the Microbial Plates. When adding new Microbial Plates, admin should enter microbial plate details.

FIG. 14B depicts an illustration of a device showing a microorganism page. At 1404, Micro-Basic Record page (Microbe Type, Plate info, Incubation) displays CFU/plate data for a table and/or a floor.

FIG. 14C depicts an illustration of a device showing a microorganism page. At 1406, a cancelation page has a data input field configured to receive data pertaining to the reason for the cancellation.

FIG. 14D depicts an illustration of a device showing a microorganism page. At 1408, Micro-Basic Record page (Microbe Type, Plate info, Incubation) displays CFU/plate data for a table and/or a floor.

FIG. 14E depicts an illustration of a device showing a microorganism page. At 1410, Micro-Basic Record page (Microbe Type, Plate info, Incubation) displays CFU/plate data for a table and/or a floor.

FIG. 14F depicts an illustration of a device showing a microorganism page. At 1412, a new microorganism name may be added with a micro ID, risk status, and/or a plate ID.

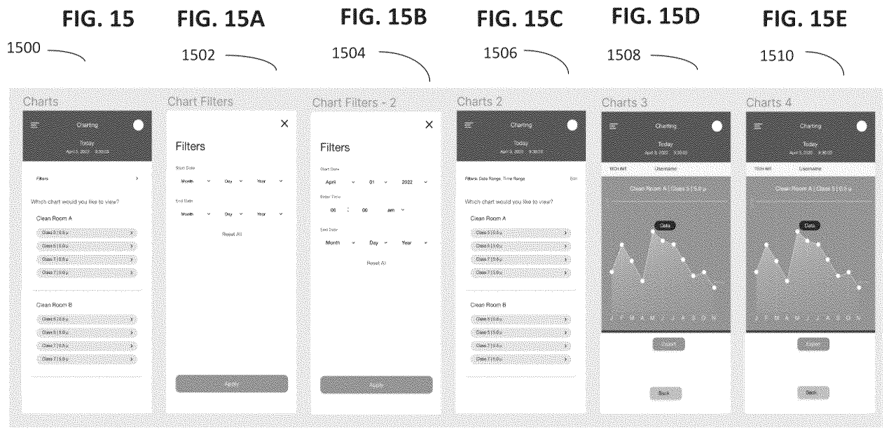

FIG. 15 depicts an illustration of a device showing a charts page. At 1500, the charts page displays a selection of chart data for Clean Room A and Clean Room B. Filters feature allows admin to specify a start and end date via a date and time picker. Depending on the selected dates, all entries within that timeframe become visible. Particle count charts are then generated based on room selection, with the option to further specify the desired particulate count within the chosen room. Users can view these charts, but no editing of information is permitted, maintaining data integrity. Pop-up selection facilitates filtering process, while the Apply button finalizes selections and returns to the previous slide. The Reset All option restores all date picker selections to default settings. Charts illustrating room selections and particulate counts are available, displaying data from January to December on the x-axis and particulate counts on a logarithmic scale on the y-axis. Users can export charts to PDF format and access transactional records for specific dates by clicking on individual data points.

FIG. 15A depicts an illustration of a device showing a charts page. At 1502, the filters page displays start date and end date data.

FIG. 15B depicts an illustration of a device showing a charts page. At 1504, the filters page displays the start date being Apr. 1, 2022 and an end time option.

FIG. 15C depicts an illustration of a device showing a charts page. At 1506, the charts page displays a selection of chart data for clean rooms and display class types and particle counts by the filter criteria. Particle count is calculated for each clean room. This will help admin determine if a room needs to be cleaned or not. Chart should include all activity of work performed and verified. When a user logs in to the app, it should be stored in the audit log so that admin knows when a person logged in. Each audit log should be clickable to show all information for a particular item. For example, if cleaning was the item, then all cleaning data for the day should be viewable. The audit log should also be searchable by data range, cleaning, disinfecting, particle counting, and micro counting so that admin can look back in the history for patterns or problems, such as missing cleanings. Each chart should also be a rolling set of numbers on a graph that plots dates, upper spec limit (aka Action Limit) versus output datapoint (95% UCL-Particles, Overall Average-Micro). A two-tiered data informatics graph should be used. These charts should be date-searchable.

FIG. 15D depicts an illustration of a device showing a charts page. At 1508, the charts page displays an analytics chart and export document.

FIG. 15E depicts an illustration of a device showing a charts page. At 1510, the charts page displays an analytics chart and export document.

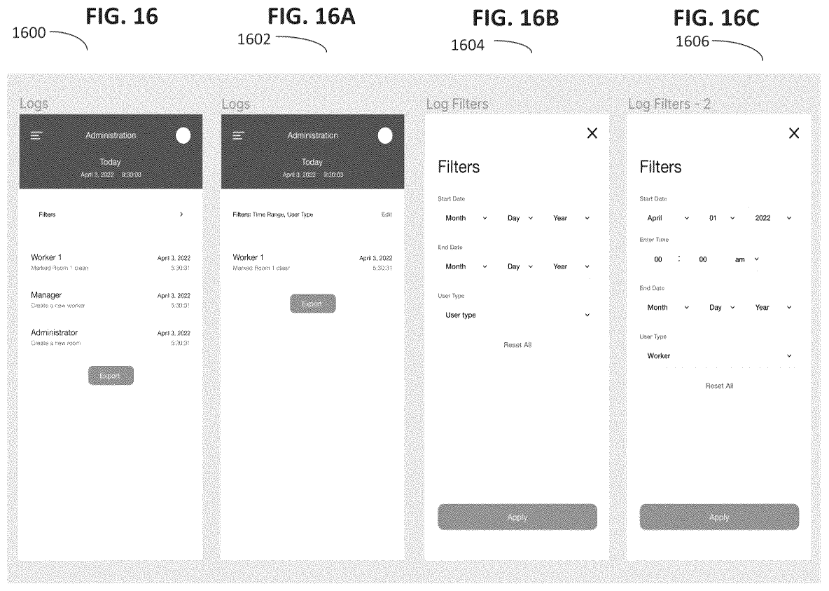

FIG. 16 depicts an illustration of a device showing an audit logs page. At 1600, work track activity is displayed as export history. Filters feature allows admins to specify a start and end date via a date and time picker. Depending on selected dates, all entries within that timeframe become visible. Particle count charts are generated based on room selection, with the option to specify desired particulate count within a chosen room. Users can view charts, but no editing of information is permitted, maintaining data integrity. Pop-up selection facilitates the filtering process, while the Apply button finalizes selections and returns to the previous slide. Reset All option restores all date picker selections to default settings. Charts illustrating various room selections and particulate counts are available, displaying data from January to December on the x-axis and particulate counts on a logarithmic scale on the y-axis. Users can export charts to PDF format and access transactional records on specific dates by clicking individual data points. For example, at the end of each workday, workers log their activity, recording the duration of their work, which provides admins with insights into their working hours. Authorized users, including admins, can view all audit logs and charts, ensuring transparency and accountability. However, editing privileges are restricted to maintain data integrity. Admins can monitor time logged by workers and have full visibility of audit logs and charts without the ability to alter. This system ensures accurate record-keeping while granting appropriate access levels to different user roles.

FIG. 16A depicts an illustration of a device showing an audit logs page. At 1602, work activity is displayed as export history based on time range and user type filter criteria. This filter identifies the type of user and the user start and end date.

FIG. 16B depicts an illustration of a device showing an audit logs page. At 1604, work activity is displayed as export history based on time range and user type filter criteria.

FIG. 16C depicts an illustration of a device showing an audit logs page. At 1606, a filter may include, but not be limited to, user type, start date, and/or end date.

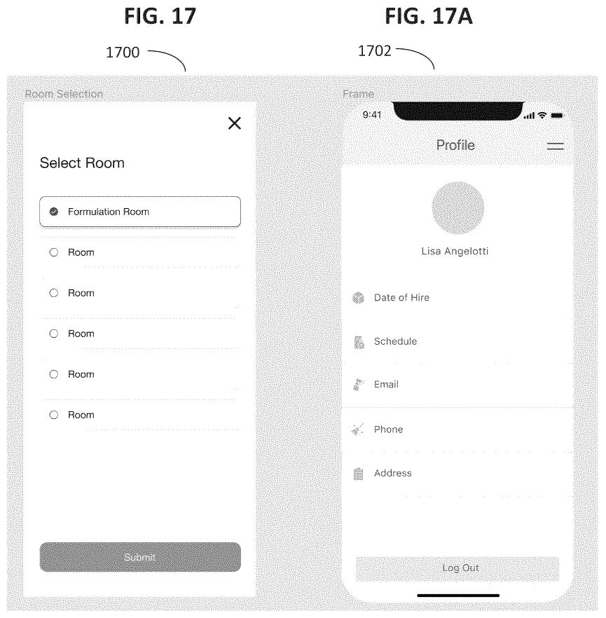

FIG. 17 depicts an illustration of a device showing admin panel implementing a room selection page. At 1700, rooms may be switched and/or selected by user during use. User may be allowed to set up a user preference irrespective of whether they are admin or not. In the app, admins have control over room management, allowing them to add, edit, and delete rooms by name. Within each room, admins input information regarding locations and the agents used for data collection in admin panel. App modules begin with room selection and options predetermined by admin panel. Admins can add users to the system, specifying their names, positions, and rooms they are assigned to for cleaning duties. The app ensures efficient organization and resource allocation within the cleanroom environment.

FIG. 17A depicts an illustration of a device showing a frame page. At 1702, profile data includes, but is not limited to a user's name, date of hire, schedule, email, phone, and/or address. Admin can create and view all user profiles. Admin can create and view their profile and edit settings to give specific user access. For example, privilege to choose dashboard color scheme. In one embodiment, the processing system is integrated onto a single silicon die or package, combining the CPU and the parallel processor to establish a unified programming and execution environment.

Alternatively, CPU and parallel processor may be separately formed and mounted. The system encompasses various software, hardware, and firmware components, potentially including input interfaces, non-volatile storage, output interfaces, network interfaces, and displays. The system incorporates a system memory, an operating system, communications infrastructure, and one or more applications. Memory access is managed by a memory controller, facilitating requests from CPU and other devices. Applications execute commands both at the CPU and parallel processor, with the operating system and communications infrastructure supporting these functions. The system includes a device driver and a memory management unit like an input/output memory management unit (IOMMU). Components can be implemented as hardware, firmware, software, or a combination thereof, potentially involving additional components beyond those mentioned.

System memory comprises non-persistent memory, such as DRAM, storing processing logic instructions, constant values, variable values, and other necessary information. Control logic commands, application functions, and system software reside within system memory during execution. Communications infrastructure interconnects system components, utilizing various communication interfaces such as PCI, PCI-E, AMBA, AGP, and Ethernet. A device driver facilitates communication with devices like the parallel processor via communications infrastructure. A compiler may be embedded within the device driver to compile source code into program instructions. The device driver controls parallel processor operation, providing an API for software executing at the CPU to access parallel processor functionality. The CPU, which may include a control processor, FPGA, ASIC, or DSP, executes control logic governing system operation, including the operating system, applications, and device driver. It manages application execution by distributing processing tasks across CPU and other resources, such as the parallel processor, which specializes in executing selected functions, such as graphics operations, utilizing parallel processing techniques. Examples of parallel processors include GPUs, massively parallel processors, SIMD architecture processors, and SIMT architecture processors. They can be separate devices or integrated into a single device with a CPU-like host processor. A parallel processor usually handles graphics pipeline operations and compute processing operations based on CPU commands, executed by specialized dispatch or command processors.

In various embodiments, the parallel processor includes one or more compute units that are processor cores including one or more SIMD units (not shown) that execute a thread concurrently with execution of other threads in a wavefront, e.g., according to a single-instruction, multiple-data (SIMD) execution model. SIMD execution model is one in which multiple processing elements such as arithmetic logic units (ALUs) share a single program control flow unit and program counter and thus execute the same program but are able to execute that program with different data. Some parallel processor embodiments are used to implement a GPU and, in that case, the compute units are referred to as shader cores or streaming multi-processors (SMXs). Number of compute units implemented in the parallel processor is a design choice. An application executing at one or more of the compute units is a software client. A parallel processor includes key components for advanced operational control and management. For example, a console within the processing system serves as a user interface or control panel, providing users with access to system functions, configurations, and potentially diagnostic tools. It may offer a graphical interface or a command-line interface, depending on the system's design and requirements. A DRS is a component responsible for managing and optimizing resource allocation across distributed computing resources within the system. It dynamically balances workloads, reallocates resources, and ensures utilization of available computing resources such as CPU, memory, and storage across multiple nodes or servers. Network Processing System (NPS) refers to a subsystem or module within the processing system handling network-related tasks and traffic. This typically includes hardware, firmware, and software optimized for tasks such as packet processing, routing, firewalling, and traffic management, ensuring efficient and secure network operations. SPA is a specialized hardware device or subsystem designed to handle storage-related operations within the processing system. It may include features such as storage virtualization, data deduplication, compression, encryption, and RAID (Redundant Array of Independent Disks) management. SPA optimizes storage performance, reliability, and efficiency, serving as a key component in data storage and management solutions.

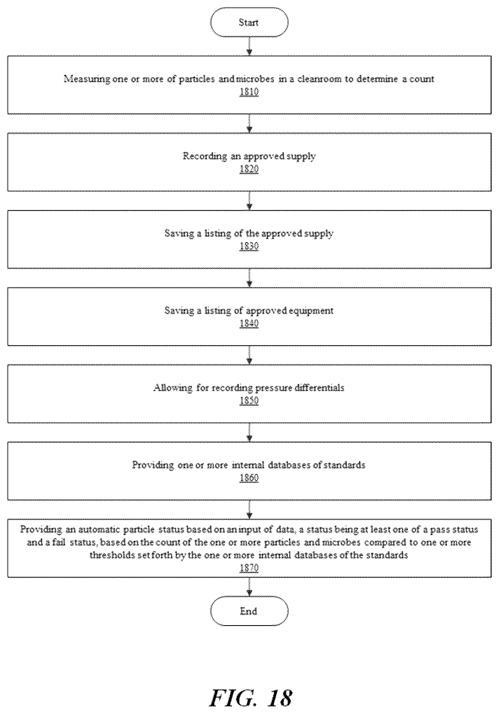

FIG. 18 is a flowchart describing a computer-implemented method (method) automating cleanroom certification validation, according to some embodiments of the present disclosure. In some embodiments, at 1810, the method may include measuring one or more of particles and microbes in a cleanroom to determine a count. At 1820, the method may include recording an approved supply. At 1830, the method may include saving a listing of the approved supply. At 1840, the method may include saving a listing of approved equipment. In some embodiments, at 1850, the method may include allowing for recording pressure differentials. At 1860, the method may include providing one or more internal databases of standards. At 1870, the method may include providing an automatic particle status based on an input of data, a status being at least one of a pass/fail status, based on the count of the one or more particles and microbes compared to one or more thresholds set forth by the one or more internal databases of the standards. In some embodiments, the one or more internal databases of the standards may be selected from a group consisting of at least one of ISO, FS-209E, PIC, and S of the cleanroom. In some embodiments, the input of data may be one or more cleaning agents. In some embodiments, the method may include activating a cleaning process to disinfect the cleanroom with the one or more cleaning agents via control logic circuitry. In some embodiments, the method may include monitoring differential pressures between the cleanroom and an adjacent room via a pressure sensor. In some embodiments, the pass/fail status may be based on criteria stored from admin inputs for each datapoint per plate and overall average for the cleanroom.

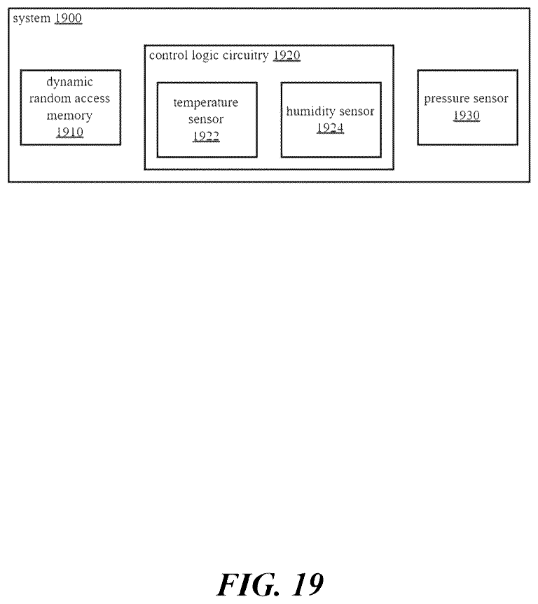

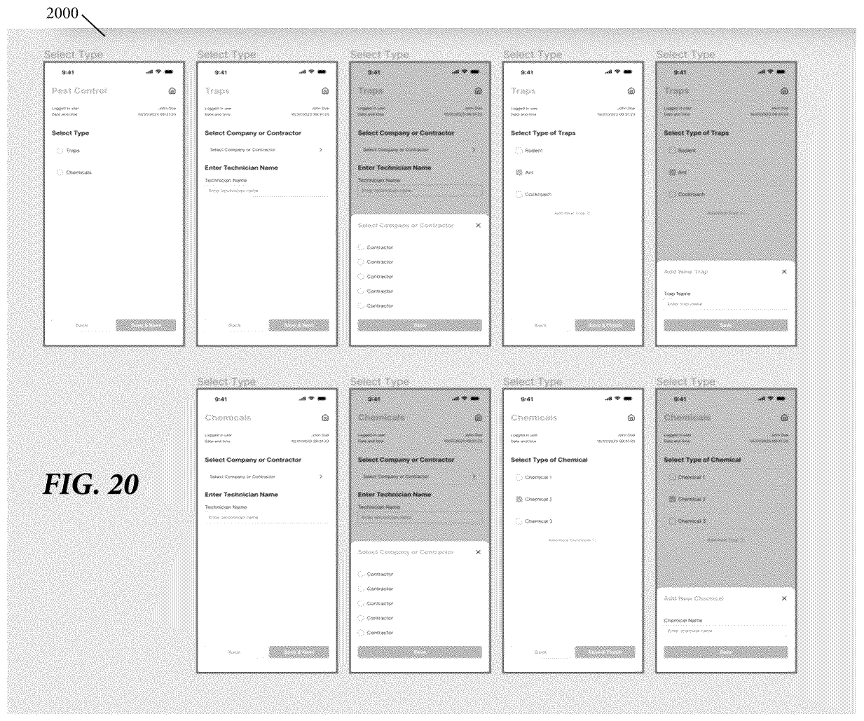

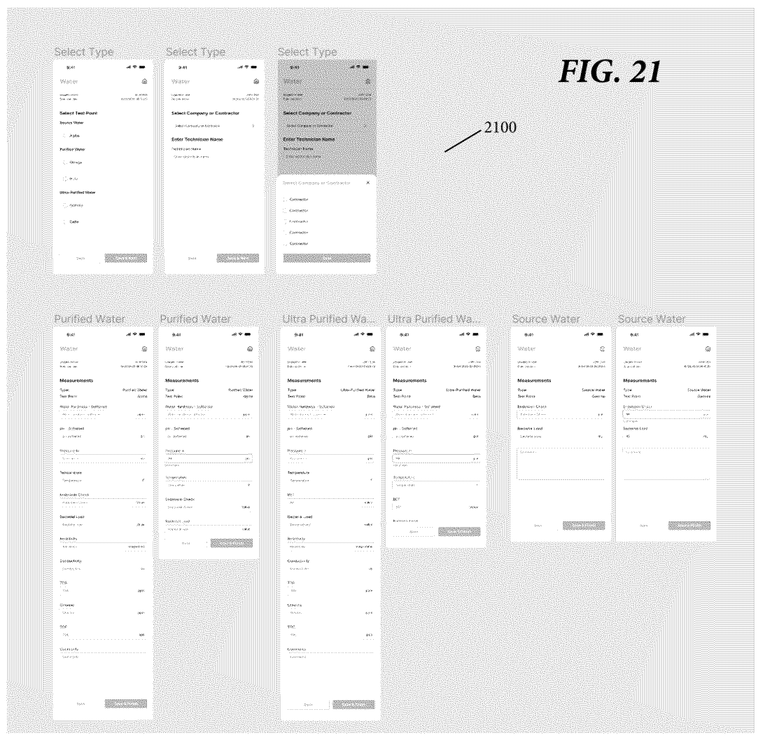

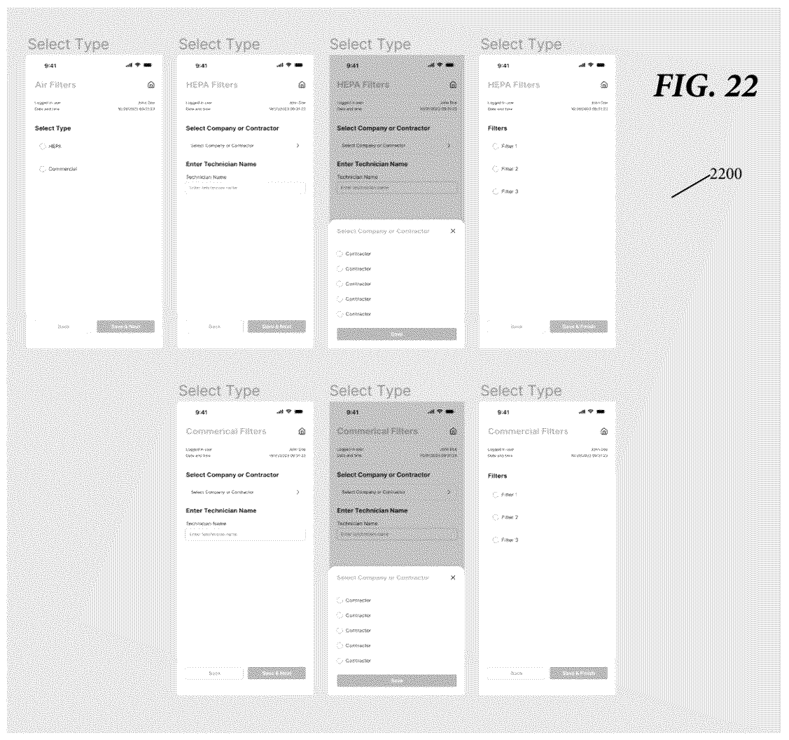

FIG. 19 is a block diagram that describes a system 1900, according to some embodiments of the present disclosure. In some embodiments, system 1900 may include a dynamic random access memory 1910 (DRAM), control logic circuitry 1920 configuration, and a pressure sensor 1930 to monitor differential pressures between cleanrooms. Control logic circuitry 1920 may include a temperature sensor 1922 and a humidity sensor 1924 to measure temperature and humidity within at least one room of a cleanroom at a predetermined time frequency. In some embodiments, the system is configured to receive an input of data to produce an audit log. Measure a microbial count, using a microbial sensor and determine if a number of microorganisms present in the cleanroom may be within a threshold. Measure a particle count, using a particle count sensor and determine if a number of airborne particles present in the cleanroom may be within a threshold. Automatically determine a pass/fail status for particles and microorganisms responsive to one or more internal database of standards. In some embodiments, the system is configured to generate charts using BI data analytics. One or more internal database of standards may be selected from a group. At least one of ISO, FS-209E, PIC, and S of the cleanroom. Input of data may be one or more cleaning agents. Control logic circuitry 1920 to activate a cleaning process to disinfect the cleanroom with one or more cleaning agents. Pass/fail status may be based on criteria stored from admin inputs for each datapoint per plate and overall cleanroom average.

FIG. 20 depicts an illustration of a device showing a pest control workflow 2000, according to at least some embodiments disclosed herein. An integrated pest management (IPM) system is designed to provide efficient and environmentally responsible pest control solutions in cleanroom environments. The system incorporates traps and treatments targeting pest species such as rodents, ants, and cockroaches, while prioritizing humane and eco-friendly methods. Chemical agents utilized are selected for their effectiveness against pests and minimal impact on human health and the environment. System features include BI data analytics capabilities, which enable generation of charts and reports optimizing pest control strategies. An internal database of standards, including ISO, FS-209E, PIC, and S cleanroom standards, ensures compliance and quality control in pest control processes. Control logic circuitry automates disinfection process using designated cleaning agents, facilitating disinfection to meet strict cleanliness standards. The system incorporates criteria stored from admin inputs to evaluate cleanroom cleanliness, providing pass/fail status for each data point and an overall average assessment. This approach ensures reliable pest control.

FIG. 21 depicts an illustration of a device showing a water workflow 2100, according to at least some embodiments disclosed herein. In the cleanroom management system, a comprehensive water monitoring system is implemented to ensure purity and quality of the water used in the cleanroom environment. In some embodiments, this system incorporates a selection of test points placed throughout the water distribution network, denoted by alpha, beta, omega, gamma, and delta designations. These test points represent locations where water quality assessment is essential to maintain cleanroom environment integrity. Water sources feeding into the system are either purified or ultra-purified, depending upon specific requirements of the cleanroom processes. Purified water undergoes extensive filtration and treatment processes to remove impurities and contaminants, while ultra-purified water undergoes additional purification steps to achieve higher purity levels. At each test point, a series of measurements are conducted to evaluate various parameters that could impact water quality. These measurements include, but are not limited to, water hardness, pH level, temperature, endotoxin levels, bacterial load, resistivity, conductivity, total dissolved solids (TDS), chlorine concentration, and/or total organic carbon (TOC) content. Water hardness is assessed to determine mineral concentration present in the water, which could potentially cause scale formation or interfere with critical processes. pH level monitoring ensures water remains within the desired range for compatibility with cleanroom processes and equipment. Temperature monitoring helps maintain optimal conditions for water storage and distribution. Endotoxin checks and bacterial load assessments help identify microbial contamination that could compromise water and overall cleanroom environment cleanliness. Resistivity and conductivity measurements provide insights into overall water purity, with lower values indicating higher purity levels. TDS measurements quantify concentration of dissolved solids in water, while chlorine monitoring ensures disinfection levels are sufficient to control microbial growth without exceeding safe limits. TOC analysis detects organic contaminants that may be present in the water, ensuring it meets stringent purity standards. Continuously monitoring these parameters at strategic test points throughout the water system allows the system to proactively identify any deviations from desired quality standards and take prompt corrective action. This approach helps to safeguard cleanroom environment integrity.

FIG. 22 depicts an illustration of a device showing an air filter workflow 2200, according to at least some embodiments disclosed herein. In the cleanroom management system, the filtration system maintains cleanliness and purity of the controlled environment. The selection and deployment of appropriate High Efficiency Particulate Air (HEPA) or commercial filters are configured to meet stringent requirements of the cleanroom environment. The first step in the filtration process involves an analysis of contaminants present in the air within the cleanroom. This analysis includes identifying particulate matter, microbial agents, volatile organic compounds (VOCs), and/or other airborne impurities that may compromise the cleanliness standards. Based on this analysis, the appropriate type of filter is selected to capture and remove these contaminants from the air. HEPA filters are commonly employed in cleanroom environments due to their high efficiency in removing airborne particles down to a size of 0.3 micrometers with an efficiency of 99.97% or higher. These filters may consist, in some embodiments, of a dense mat of randomly arranged fibers creating a labyrinthine pathway for air to pass through, thus trapping particles as small as viruses and bacteria. HEPA filter selection is based on factors such as filtration efficiency, pressure drop, and airflow capacity, all of which are carefully optimized to maintain desired cleanroom air quality. Filtration system design includes considerations for filter size, configuration, and placement to ensure uniform air distribution and minimize turbulence.

In certain applications where specific contaminants or airborne pathogens pose a greater risk, specialized commercial filters may be utilized in conjunction with or as an alternative to HEPA filters. These commercial filters may incorporate additional features such as activated carbon or molecular sieves to adsorb VOCs or gases, further enhancing air quality within the cleanroom environment. In addition, the filtration system is equipped with monitoring and control mechanisms to continuously assess filter performance and integrity. Differential pressure sensors, particle counters, and air quality monitors are employed to measure key parameters and detect any deviations from desired standards. Automated controls are integrated to adjust airflow rates, activate filter change alerts, and optimize filtration efficiency in real-time. The cleanroom management system filtration system is engineered to ensure uncompromising cleanliness and purity, safeguarding the integrity of critical processes and sensitive products manufactured within the cleanroom environment.

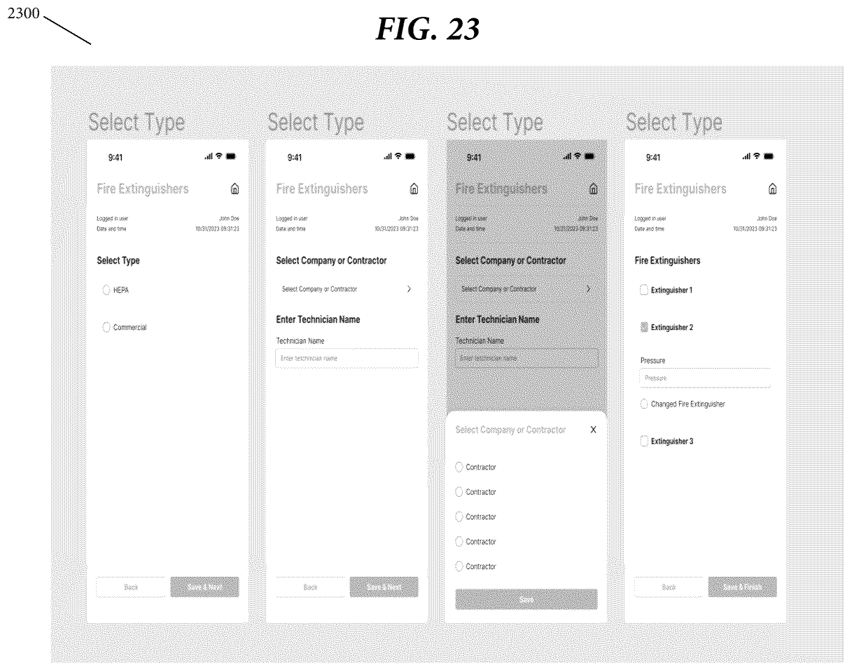

FIG. 23 depicts an illustration of a device showing a fire extinguishers workflow 2300, according to at least some embodiments disclosed herein. Integral to this system is a monitoring mechanism continuously assessing pressure levels of fire extinguishers, providing real-time data to determine when they should be replaced or recharged. Fire extinguishers deployed within the cleanroom facility are equipped with pressure gauges or sensors measuring internal pressure of the extinguishing agent, typically compressed air or nitrogen, contained within the cylinder. Pressure gauges are connected to the cleanroom management system's monitoring infrastructure, allowing for seamless integration and automated monitoring of extinguisher status. Through the system's centralized control interface, facility personnel have access to real-time pressure readings from each fire extinguisher deployed in the facility. Threshold values are established based on industry standards and manufacturer specifications, defining the acceptable pressure range for effective fire suppression. As extinguisher pressure decreases over time due to natural leakage or gradual discharge, the monitoring system continuously evaluates pressure readings against predetermined threshold values. When pressure falls below the designated threshold, indicating a diminished capacity for effective fire suppression, the system triggers an alert or notification to prompt proactive action. Maintenance personnel are notified of the extinguisher requiring attention, enabling timely replacement or recharge to restore it to optimal working condition. Automated work order generation and tracking streamline the process, ensuring necessary maintenance tasks are addressed without compromising safety or operational continuity. Historical pressure data and trends are logged and analyzed within the system, enabling predictive maintenance strategies and optimization of fire extinguisher replacement schedules. Through data-driven insights, personnel can proactively manage extinguisher maintenance and replacement, minimizing downtime and mitigating risks associated with fire emergencies.

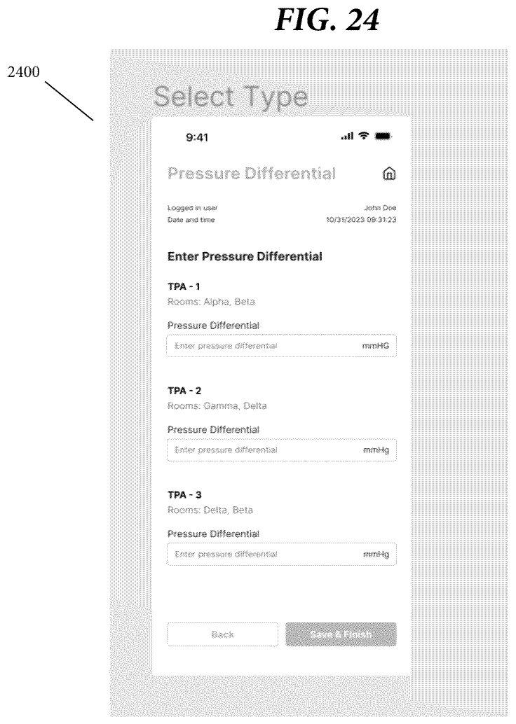

FIG. 24 depicts an illustration of a device showing a pressure differentials workflow 2400, according to at least some embodiments disclosed herein. The cleanroom management system may be configured to monitor pressure differentials between key rooms within the controlled environment. This system leverages advanced pressure sensing technology to continuously assess and compare pressure levels in specific room pairs, ensuring optimal fire suppression and safety conditions. Cleanroom facility rooms are categorized into pairs, such as alpha and beta, gamma and delta, and delta and beta, based on spatial proximity and functional requirements. Each room pair is equipped with pressure sensors positioned to measure pressure differentials in units of millimeters of mercury (mmHg). These sensors are integrated into the system's monitoring infrastructure, allowing for real-time data collection and analysis. The system continuously monitors pressure differentials between room pairs, comparing pressure readings from corresponding sensors. Threshold values are established based on industry standards and regulatory requirements, defining acceptable pressure differentials for each room pair. Deviations from thresholds trigger automated alerts or notifications within the system, prompting immediate attention from personnel.

For example, if the pressure in room alpha exceeds room beta by a significant margin, indicating a potential imbalance in airflow or ventilation, the monitoring system will alert operators to investigate and rectify the issue. Similarly, pressure differentials between rooms gamma and delta, and delta and beta are continuously monitored to ensure consistent airflow patterns and prevent the migration of contaminants or fire hazards between adjacent spaces. Personnel are equipped with real-time visibility into pressure differentials across room pairs, enabling them to identify and address potential issues before they escalate. By proactively managing pressure differentials, the system enhances effectiveness of fire suppression measures and mitigates risk of fire propagation. Also, historical pressure data and trends are logged and analyzed within the system, providing insights into airflow dynamics and system performance over time. This data-driven approach enables predictive maintenance strategies and continuous optimization of cleanroom operations, ultimately enhancing safety.

It will thus be seen that the objects set forth above, and those made apparent from the foregoing description, are efficiently attained. Since certain changes may be made in the above construction without departing from the scope of the invention, it is intended that all matters contained in the foregoing description or shown in the accompanying drawings shall be interpreted as illustrative and not in a limiting sense. It is also to be understood that the description is intended to cover all of the generic and specific features of the invention herein described, and all statements of the scope of the invention that, as a matter of language, might be said to fall therebetween.

The computer readable storage media/medium can be a tangible device that can retain and store instructions for use by an instruction execution device. Computer readable storage media/medium may be, for example, but is not limited to, an electronic storage device, a magnetic storage device, an optical storage device, an electromagnetic storage device, and/or a semiconductor storage device, or any suitable combination of the foregoing. A non-exhaustive list of more specific examples of the computer readable storage media/medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, and/or a mechanically encoded device (such as punch-cards or raised structures in a groove having instructions recorded thereon), and any suitable combination of the foregoing. Computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or wire transmitted electrical signals.

Aspects of the present invention are described herein regarding illustrations and/or block diagrams of methods, computer systems, and computing devices according to embodiments of the invention. It will be understood that each block in the block diagrams, and combinations of the blocks, can be implemented by computer-readable instructions (e.g., the program code). Computer-readable instructions are provided to the processor of a general purpose computer, special purpose computer, or other programmable data processing apparatus (e.g., the computing device) to produce a machine, such that the instructions, which execute via the processor of the computer or other programmable data processing apparatus, create means for implementing the functions/acts specified in the block diagram blocks. Computer-readable instructions are stored in a computer-readable storage medium that can direct a computer, a programmable data processing apparatus, and/or other devices to function in a particular manner, such that the computer-readable storage medium having instructions stored therein comprises an article of manufacture including instructions, which implement aspects of the functions/acts specified in the block diagram blocks. Computer-readable instructions (e.g., the program code) are also loaded onto a computer (e.g., the computing device), another programmable data processing apparatus, or another device to cause a series of operational steps to be performed on the computer, the other programmable apparatus, or the other device to produce a computer implemented process, such that the instructions, which execute on the computer, the other programmable apparatus, or the other device, implement functions/acts specified in block diagram blocks. Computer readable program instructions described herein can also be downloaded to respective computing/processing devices from a computer readable storage medium or to an external computer or external storage device via a network (e.g., the Internet, a local area network, a wide area network, and/or a wireless network). Network may comprise copper transmission cables, optical transmission fibers, wireless transmission, routers, firewalls, switches, gateway computers, and/or edge servers. Network adapter card or network interface in each computing/processing device receives computer readable program instructions from the network and forwards computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer/computing device, partly on the user's computer/computing device, as a stand-alone software package, partly on the user's computer/computing device and partly on a remote computer/computing device or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention. Aspects of the present invention are described herein with reference to block diagrams of methods, computer systems, and computing devices according to embodiments of the invention.

It will be understood that each block and combinations of blocks in the diagrams, can be implemented by the computer readable program instructions. Block diagrams in the Figures illustrate the architecture, functionality, and operation of possible implementations of computer systems, methods, and computing devices according to various embodiments of the present invention. In this regard, each block in the block diagrams may represent a module, a segment, or a portion of executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon functionality involved. It will also be noted each block and combinations of blocks can be implemented by special purpose hardware-based systems that perform the specified functions or acts or carry out combinations of special purpose hardware and computer instructions. Another embodiment of the invention provides a method that performs the process steps on a subscription, advertising, and/or fee basis. That is, a service provider can offer to assist in one or more of the method steps. In this case, the service provider can create, maintain, and/or support, etc. a computer infrastructure that performs process steps for one or more customers. In return, the service provider can receive payment from the customer(s) under a subscription and/or fee agreement, and/or the service provider can receive payment from the sale of advertising content to one or more third parties.

It will be further understood that the terms “comprises,” “comprising,” “includes,” and/or “including.” when used herein, specify presence of stated features, integers, steps, operations, elements, and/or components, but do not preclude presence or addition of one or more other features, integers, steps, operations, elements, components, and/or groups thereof. Descriptions of various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. Terminology used herein was chosen to best explain the principles of the embodiments, the practical application or technical improvement over technologies found in the marketplace, or to enable others or ordinary skill in the art to understand the embodiments disclosed herein.

When introducing elements of the present disclosure or the embodiments thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements. Although this invention has been described with a certain degree of particularity, it is to be understood that the present disclosure has been made only by way of illustration and that numerous changes in the details of construction and arrangement of parts may be resorted to without departing from the spirit and the scope of the invention. Now that the invention has been described,

What is claimed is:

1. A system to determine cleanroom certification status, comprising: a dynamic random access memory (DRAM); and control logic circuitry configured to: receive an input of data to produce an audit log; measure temperature and humidity, using temperature sensor and humidity sensor within at least one room of a cleanroom at predetermined time frequency; measure a microbial count, using a microbial sensor and determine if a number of microorganisms present in the cleanroom is within a threshold; measure a particle count, using a particle count sensor and determine if number of airborne particles in cleanroom is within a threshold; automatically determine a pass or fail status for particles and microorganisms responsive to one or more internal database of standards; and generate charts using Business Intelligence (BI) data analytics.

2. The system of claim 1, wherein one or more internal database of standards is selected from a group consisting of at least one of ISO, FS-209E, PIC, and S of the cleanroom.

3. The system of claim 1, wherein the input of data is one or more cleaning agents.

4. The system of claim 3, wherein the control logic circuitry to activate a cleaning process to disinfect the cleanroom with the one or more cleaning agents.

5. The system of claim 1, wherein the control logic circuitry to generate a notification of the pass or fail status to.

6. The system of claim 1, further comprising: a pressure sensor to monitor differential pressures between the cleanroom and an adjacent room.

7. The system of claim 1, wherein the pass or fail status is based on criteria stored from admin inputs for each datapoint per plate and overall average for the cleanroom.

8. A computer-implemented method for automated validation for clean room certification, comprising: measuring one or more of particles and microbes in a cleanroom to determine a count; and recording an approved supply; saving a listing of the approved supply; saving a listing of approved equipment; allowing for recording pressure differentials; providing one or more internal databases of standards; and providing an automatic particle status based on data input, a status being at least one of a pass/fail status, based on count of one or more particles and microbes compared to one or more thresholds set forth by one or more internal databases of standards.

9. The computer-implemented method of claim 8, wherein the one or more internal databases of the standards is selected from a group consisting of at least one of ISO, FS-209E, PIC, and S of the cleanroom.

10. The computer-implemented method of claim 8, wherein the input of data is one or more cleaning agents.

11. The computer-implemented method of claim 10, further comprising: cleaning process disinfecting cleanroom activated by one or more cleaning agents via control logic circuitry.

12. The computer-implemented method of claim 8, further comprising: monitor differential pressures between cleanroom and an adjacent room via pressure sensor.

13. The computer-implemented method of claim 8, wherein the pass status or the fail status is based on criteria stored from admin inputs for each datapoint per plate and overall average for the cleanroom.

14. A computer-readable medium comprising instructions which, when executed by a computer, cause the computer to carry out the steps of: providing a dynamic random access memory (DRAM); and providing a control logic circuitry configured to: receive an input of data to produce an audit log; measure temperature and humidity, using a temperature sensor and a humidity sensor within at least one room of a cleanroom at a predetermined time frequency; measure a microbial count, using a microbial sensor and determine if a number of microorganisms present in the cleanroom is within a threshold; measure a particle count, using a particle count sensor and determine if a number of airborne particles present in the cleanroom is within a threshold; automatically determine a pass status or a fail status for particles and microorganisms responsive to one or more internal database of standards; and generate charts using Business Intelligence (BI) data analytics.

15. The computer-readable medium of claim 14, wherein the one or more internal database of standards is selected from a group consisting of at least one of ISO, FS-209E, PIC, and S of the cleanroom.

16. The computer-readable medium of claim 14, wherein the input of data is one or more cleaning agents.

17. The computer-readable medium of claim 16, wherein the control logic circuitry to activate cleaning process to disinfect the cleanroom with one or more cleaning agents.

18. The computer-readable medium of claim 14, wherein the control logic circuitry to generate a notification of the pass status or the fail status to.

19. The computer-readable medium of claim 14, further comprising: a pressure sensor to monitor differential pressures between the cleanroom and an adjacent room.

20. The computer-readable medium of claim 14, wherein pass or fail status is based on stored admin input criteria for each datapoint per plate and overall cleanroom average.
